(19) United States
(12) Patent Application Publication
(10) Pub. No.: US 2015/0135279 A1
(43) Pub. Date: May 14, 2015

(54) PERSONAL IDENTITY CONTROL

(71) Applicant: CallSign, Inc., Los Altos, CA (US)

(72) Inventor: Zia Hayat, Surrey (GB)

(21) Appl. No.: 14/598,673

(22) Filed: Jan. 16, 2015

Related U.S. Application Data
(62) Division of application No. 14/002,161, filed on Oct. 22, 2013.

(51) Int. Cl. H04L 29/06; G06Q 20/40

(52) U.S. Cl. CPC H04L 63/10; G06Q 20/40
USPC 726/4

(57) ABSTRACT

Obtaining authorization from a subscriber to an authorization service provided by an authorization provider in a data communications system. The data communications system includes a plurality of relying parties and a plurality of authorization providers. An authorization request including data identifying a subscriber to an authorization service is received from a relying party. An authorization provider is selected from the plurality of authorization providers on the basis of the subscriber-identifying data. An authorization request is transmitted to the selected authorization provider. An authorization response is received from the selected authorization provider. The authorization response indicates that the subscriber has authorized the request on a telecommunications device with which contact has been initiated by the authorization provider in response to the authorization request. An authorization message is transmitted to the relying party based at least in part on the authorization response received from the selected authorization provider.

### TECHNICAL FIELD

The present disclosure relates to obtaining authorization from a subscriber to an authorization service provided by an authorization provider in a data communications system.

### BACKGROUND

Personal Identity Control is a significant area of technological progress. Much effort has been devoted to improving the security of identity (ID)-related services. ID-related services can broadly be described as any personal service which requires credentials (for example name, address or credit card details) to be exchanged and asserted.

Processes that form the basis of such services include, but are not limited to:
Cardholder Not Present (CNP) payments, where a user purchases goods or services remotely, for example when they are not physically present at a merchant location;
bank payments, where a user sets up a new payment beneficiary on a one-off or recurring basis;
account login, where a user gains access to a previously registered account; and
account registration, where a user registers to gain access to a new account.

Managing the security risks associated with ID-related services is becoming an increasingly difficult task for both users and service providers. This is highlighted by the plethora of bespoke anti-fraud and security solutions imposed upon users today, by retailers and banks, in both remote (online and telephone) and face-to-face environments.

The concept of identity federation was introduced a number of years ago, whereby one party or entity, a Relying Party (RP), accepts credentials asserted by another party, an Identity Provider (IDP). For example, an online merchant acting as an RP may allow a user to login through an assertion made by the user's IDP. Such a solution enables users to use one set of credentials (for example a username and password) to access several accounts. This functionality is commonly referred to as Single Sign-On (SSO).

Herein, the term ‘Third Party Validator (TPV)’ is used to describe entities, such as Merchant Acquirers (MAs), Payment Processors (PPs) and Credit Reference Agencies (CRAs), upon which RPs rely to authorize CNP payment transactions or to validate a user's identity or age.

The primary security limitation of existing Third Party Validators is their assumption that personal information (for example payment card details, address and date of birth) is secret in the sense that it is known only to the user. However, with the advent of powerful search engines and social networking platforms, this assumption is becoming increasingly flawed.

A number of solutions have been developed to deliver identity federation. These have primarily been based upon industry standards such as InfoCards, OpenID, Liberty Alliance, SAML and OAuth.

A common example of a solution which uses such standards, specifically OpenID, is Facebook Connect, which enables a user to log on to a RP's website, using their Facebook username and password. Log-on is effected by the RP redirecting the user's web browser to a Facebook login portal when they wish to login to the RP's website. Other implementations of a similar technique include Google Accounts and Symantec Personal Identity Portal (PIP).

However, while such solutions have enabled individual RPs and IDPs to interface, there remain some factors that may be less than desirable, in particular when it comes to obtaining authorization from a subscriber to an IDP service.

It would be desirable to allow a user to subscribe to an IDP service that they trust, thus providing flexibility, whilst allowing RPs to readily integrate with a wide variety of IDPs. Furthermore, obtaining explicit authorization from a subscriber on behalf of a relying party in a consistent manner provides a challenge which remains unsolved.

The present disclosure seeks to overcome or at least ameliorate some of the problems discussed above.

### SUMMARY

In accordance with an exemplary aspect of the present disclosure, there is provided a method of obtaining authorization from a subscriber to an authorization service provided by an authorization provider in a data communications system, the data communications system comprising:

a plurality of relying parties; and

a plurality of authorization providers adapted for:

receiving, from a relying party, an authorization request, the request including data identifying a subscriber to an authorization service;

selecting an authorization provider, from said plurality of authorization providers, on the basis of the subscriber-identifying data;

transmitting an authorization request to the selected authorization provider;

receiving an authorization response from the selected authorization provider, the authorization response indicating that the subscriber has authorized the request on a telecommunications device with which contact has been initiated by the authorization provider in response to the authorization request; and

transmitting, to the relying party, an authorization message based at least in part on the authorization response received from the selected authorization provider.

It should be noted that authorization by a subscriber on the telecommunications device may be explicit or implicit. For example explicit authorization may be given via user input to in response to an explicit authorization input request (e.g. an ‘OK to Proceed’ button). Alternatively, implicit authorization may be given by the subscriber responding to an authentication request—e.g. by inputting a secret code, such as a PIN or password, which if entered provides implicit authorization of the associated action.

In some examples, the telecommunications device includes an identity module, and wherein said authorization response indicates that the subscriber has authorized the request via a software application installed on the identity module.

In some examples, the identity module is a removable identity module.

In some examples, the removable identity module comprises a Universal Integrated Circuit Card (UICC).

Some examples comprise establishing a wireless communications session with the telecommunications device.

Some examples comprise:

prior to establishing the wireless communications session, transmitting a master key to the telecommunications device; and

using the master key to establish a secure communications session with the telecommunications device.

Some examples comprise:

prior to establishing the wireless communications session, embedding a master key into the telecommunications device; and

using the master key to establish one or more secure communications keys for administration and transaction sessions with the telecommunications device.

Some examples comprise: prior to receiving the authorization request from the relying party:

establishing a communications session with the telecommunications device for delivery of a software application; and

transmitting to the software application via the communications session.

Some examples comprise:

providing the software application with an authorization service registration authentication token, the software application being configured to authenticate the subscriber for registration to the authorization service, at the telecommunications device, if the subscriber provides the software application with an appropriate input corresponding to the authorization service registration authentication token.

Some examples comprise transmitting the authorization service registration authentication token to a postal service interface.

In some examples, the authorization request received from the relying party includes a first subscriber identifier for the subscriber. Such examples comprise:

accessing a subscriber store using the first subscriber identifier;

identifying a subscriber record for the subscriber based on the first subscriber identifier; and

obtaining a network address for the telecommunications device of the subscriber from the subscriber record.

In some examples, the method comprises obtaining authorization for a payment transaction involving the subscriber. Such examples comprise;

receiving, from the relying party, a payment authorization request identifying one or more transaction details;

accessing a subscriber record for the subscriber using the subscriber identifier and determining at least one payment option for the payment transaction.

In some examples, the method comprises obtaining authorization for a delivery transaction involving the subscriber. Such examples comprise:

receiving, from the relying party, a delivery authorization request identifying one or more transaction details;

accessing a subscriber record for the subscriber using the subscriber identifier and determining at least one delivery option for the payment transaction.

In some examples, the one or more transaction details comprise the identity of the relying party and transaction data for which authorization is sought.

In accordance with a further exemplary aspect of the present disclosure, there is provided a computer program product comprising a non-transitory computer-readable storage medium having computer readable instructions stored thereon, the computer readable instructions being executable by a computerized device to cause the computerized device to perform a method for obtaining authorization from a subscriber to an authorization service provided by an authorization provider in a data communications system, the data communications system comprising:

a plurality of relying parties; and

a plurality of authorization providers, the method comprising:

receiving, from a relying party, an authorization request, the request including data identifying a subscriber to an authorization service;

selecting an authorization provider, from said plurality of authorization providers, on the basis of the subscriber-identifying data;

transmitting an authorization request to the selected authorization provider;

receiving an authorization response from the selected authorization provider, the authorization response indicating that the subscriber has authorized the request on a telecommunications device with which contact has been initiated by the authorization provider in response to the authorization request; and

transmitting, to the relying party, an authorization message based at least in part on the authorization response received from the selected authorization provider.

In accordance with a further exemplary aspect of the present disclosure, there is provided a data communications system and a method of obtaining authorization from a subscriber to an authorization service provided by an authorization provider in a data communications system, the data communications system comprising:

an authorization platform which is configured to receive authorization requests from a plurality of relying parties; and

a plurality of telecommunications devices, the method comprising:

receiving, from the authorization platform, an authorization request, the request including data identifying the subscriber;

initiating contact with a telecommunications device in response to the authorization request;

receiving an authorization response, the authorization response indicating that the subscriber has authorized the request on the telecommunications device; and

transmitting, to the authorization platform, an authorization message based at least in part on the received authorization response.

Some examples comprise mapping said subscriber-identifying data to a telecommunications device identity; and

transmitting an authorization request to the telecommunications device using the telecommunications device identity.

In accordance with a further exemplary aspect of the present disclosure, there is provided a computer program product comprising a non-transitory computer-readable storage medium having computer readable instructions stored thereon, the computer readable instructions being executable by a computerized device to cause the computerized device to perform a method for obtaining authorization from a subscriber to an authorization service provided by an authorization provider in a data communications system, the data communications system comprising:

an authorization platform which is configured to receive authorization requests from a plurality of relying parties; and

a plurality of telecommunications devices, the method comprising:

receiving, from the authorization platform, an authorization request, the request including data identifying the subscriber;

initiating contact with a telecommunications device in response to the authorization request;

receiving an authorization response, the authorization response indicating that the subscriber has authorized the request on the telecommunications device; and

transmitting, to the authorization platform, an authorization message based at least in part on the received authorization response.

In accordance with a further exemplary aspect of the present disclosure, there is provided a method of obtaining authorization from a subscriber to an authorization service provided by an authorization provider in a data communications system, the data communications system comprising:

a plurality of authorization providers configured to receive authorization requests sent on behalf of a plurality of relying parties; and

a plurality of telecommunications devices, the method comprising:

receiving at a telecommunications device an authorization request, the request including data identifying one or more details of a transaction to be authorized;

displaying on the telecommunications device said data identifying one or more details of the transaction to be authorized;

receiving user input authorizing the transaction; and

transmitting an authorization response from the telecommunications device, the authorization response indicating that the user has authorized the transaction.

In accordance with a further exemplary aspect of the present disclosure, there is provided a computer program product comprising a non-transitory computer-readable storage medium having computer readable instructions stored thereon, the computer readable instructions being executable by a computerized device to cause the computerized device to perform a method for obtaining authorization from a subscriber to an authorization service provided by an authorization provider in a data communications system, the data communications system comprising:

an authorization platform which is configured to receive authorization requests from a plurality of relying parties; and

a plurality of telecommunications devices, the method comprising:

receiving, from the authorization platform, an authorization request, the request including data identifying the subscriber;

initiating contact with a telecommunications device in response to the authorization request;

receiving an authorization response, the authorization response indicating that the subscriber has authorized the request on the telecommunications device; and

transmitting, to the authorization platform, an authorization message based at least in part on the received authorization response.

In accordance with a further aspect of the present invention, there is provided a method of obtaining authorization from a subscriber to an authorization service provided by an authorization provider in a data communications system, the data communications system comprising:

a plurality of relying parties; and

an authorization platform, the method comprising:

transmitting, from a relying party, an authorization request to the authorization platform, the request including data identifying a subscriber;

receiving an authorization response from the authorization platform, the authorization response indicating that the subscriber has authorized the request on a telecommunications device with which contact has been initiated by the authorization provider in response to the authorization request.

In accordance with a further exemplary aspect of the present disclosure, there is provided a computer program product comprising a non-transitory computer-readable storage medium having computer readable instructions stored thereon, the computer readable instructions being executable by a computerized device to cause the computerized device to perform a method for obtaining authorization from a subscriber to an authorization service provided by an authorization provider in a data communications system, the data communications system comprising:

a plurality of authorization providers configured to receive authorization requests sent on behalf of a plurality of relying parties; and

a plurality of telecommunications devices, the method comprising:

receiving at a telecommunications device an authorization request, the request including data identifying one or more details of a transaction to be authorized;

displaying on the telecommunications device said data identifying one or more details of the transaction to be authorized;

receiving user input authorizing the transaction; and

transmitting an authorization response from the telecommunications device, the authorization response indicating that the user has authorized the transaction.

Further features and advantages of the disclosure will become apparent from the following description of exemplary embodiments and examples of the disclosure, given by way of example only, which is made with reference to the accompanying drawings.

### BRIEF DESCRIPTION OF THE DRAWINGS

FIGS. 1A and 1B are a schematic block diagram showing a system according to some examples.

FIG. 2 is a schematic block diagram showing a security architecture according to some examples.

FIG. 3 is a sequence diagram showing part of an initial registration procedure according to some examples.

FIG. 4 is a sequence diagram showing part of an initial registration procedure according to some examples.

FIG. 5 is a sequence diagram showing part of an initial registration procedure according to some examples.

FIG. 6 is a sequence diagram showing handling of a compromised subscriber ID according to some examples.

FIG. 7 is a sequence diagram showing a login transaction according to some examples.

FIG. 8 is a sequence diagram showing a payment transaction according to some examples.

FIG. 9 is a sequence diagram showing a new profile registration transaction according to some examples.

FIG. 10 is a sequence diagram showing a profile update transaction according to some examples.

FIGS. 11A and 11B are a flow diagram showing a transaction flow according to some examples.

### DETAILED DESCRIPTION

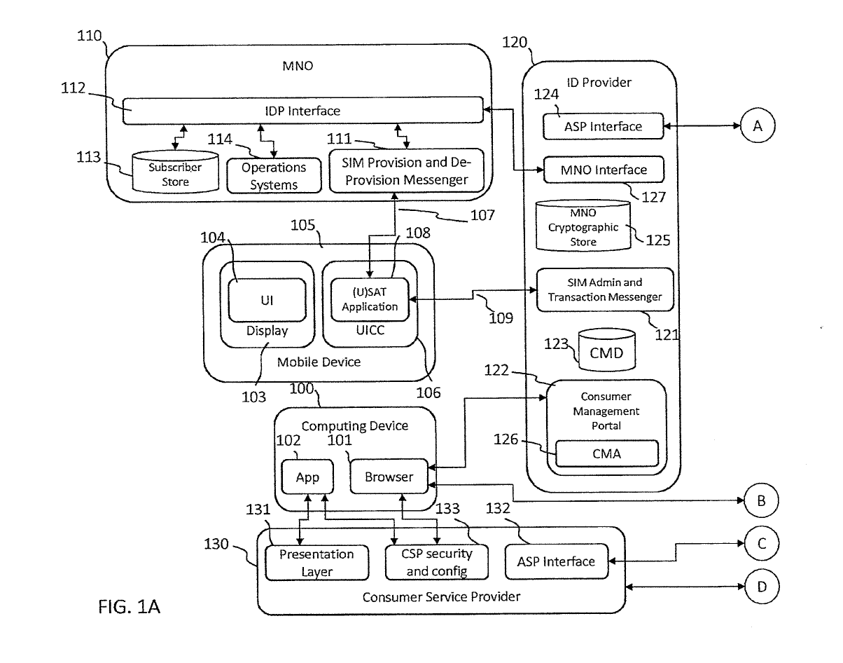

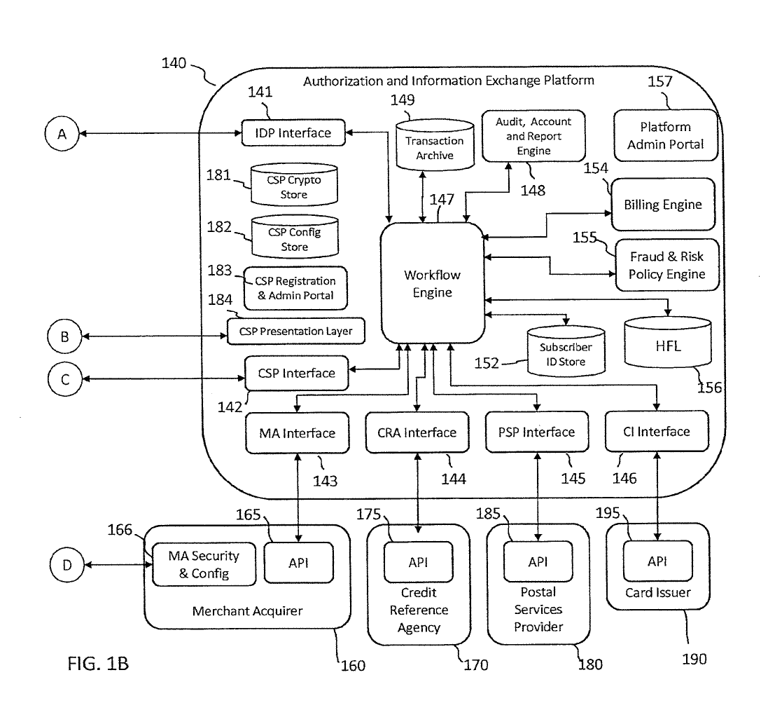

FIG. 1 shows a system diagram of a data communications system according to some examples.

The system comprises in one example a plurality of computing devices exemplified by computing device 100, a plurality of communications devices, such as telecommunications devices, exemplified by telecommunications device 105, a plurality of telecommunications service providers exemplified by telecommunications service provider 110, a plurality of authorization providers exemplified by authorization provider 120, a plurality of relying parties exemplified by relying party 130 and a central authorization platform 140. The central authorization platform 140 provides authorization and personal information exchange and is referred to herein as an Authorization Service Provider (ASP) and/or an authorization and personal information exchange platform. The term ‘consumer’ is used herein generally to denote a user who interacts with the system and includes both a registering user (a user wishing to register to become a subscriber to an authorization service) and a subscriber (a user who has registered with the authorization service provided by an authorization provider, which, in some embodiments is an Identity Provider (IDP)). The authorization provider 120 may be hosted by the authorization and personal information exchange platform 140.

FIG. 1 also shows an exemplary Merchant Acquirer (MA) 160 which may handle payment transactions for the relying party 130 via the authorization and personal information exchange platform 140, a Credit Reference Agency (CRA) 170 which may be used to obtain identification and credit information pertaining to consumers, a Postal Services Provider 180 which may be used to dispatch communications by post, physically or virtually, and a Card Issuer (CI) 195 which may issue (or may have issued) payments cards to consumers. The CI 195 may issue (or may have issued) payment instruments other than payment cards to consumers and may use the authorization and personal information exchange platform 140 to validate the authenticity of a payment request directly.

A consumer using the system has access to the computing device 100, for example a Personal Computer (PC), tablet or mobile computing device, which includes a web browser 101 and/or one or more software applications 102. The computing device 100 may be connected to the Internet by means of an Asymmetric Digital Subscriber Line (ADSL) network, a dial-up connection (via the Public Switched Telephone Network (PSTN) or an Integrated Services Digital Network (ISDN) connection)), a cable modem (via a cable television network), a mobile network, a leased line or the like.

In some examples, the communications device 105, which may be a telecommunications device, is a mobile device, but may be a fixed device. In this example, the telecommunications device is a mobile device 105 such as a cellular telephone. The mobile device 105 comprises a removable identity module such as a Universal Integrated Circuit Card (UICC) 106 which comprises one or more of a Subscriber Identity Module (SIM) (which may be used in second-generation (2G) networks, such as Global Systems for Mobile Communications (GSM) networks) and a Universal Subscriber Identity Module (USIM) (which may be used in third-generation (3G) networks such as Universal Mobile Telecommunications System (UMTS) networks). In some examples, the identity module may not be removable from the telecommunications device 105. Although the communications device 105 is described as being a cellular telephone, other communications devices such as televisions are envisaged.

The mobile device 105 communicates with a telecommunications service provider, in this case Mobile Network Operator (MNO) 110, using a radio interface 107 via a mobile network, such as a GSM or UMTS network. The mobile device 105 may communicate with other entities such as a Trusted Service Manager (TSM) or with the ASP 140.

In some examples, the UICC 106 comprises a (U)SIM Application Toolkit ((U)SAT) application 108. The (U)SAT application 108 is a software application which is executed on the UICC 106 and enables the (U)SIM to receive commands from, and send responses to, the MNO 110 via the mobile device 105. The (U)SAT application 108 may be able to receive commands from, and send responses to, the IDP 120 via the mobile device 105. The (U)SAT application 108 may provide instructions to, and receive input from, the subscriber via the mobile device 105. For example, the (U)SAT application 108 may be able to cause the mobile device 105 to run authentication algorithms, display a message or soft buttons to a user and may be capable of receiving an input from the user via the soft buttons.

The (U)SAT application 108 allows a subscriber to authorize transactions via their mobile device 105. The (U)SAT application 108 may be configured to request that the subscriber authenticate themselves to the (U)SAT application 108, for example by requiring the subscriber to enter a predetermined Personal Identification Number (PIN), password or other authentication token before it accepts authorization of a transaction by the subscriber.

The MNO 110 includes a SIM messenger 111. The SIM messenger 111 provides SIM provisioning and de-provisioning and is generally referred to herein as a SIM provisioning and de-provisioning messenger.

The SIM provisioning and de-provisioning messenger 111 is a server application that is installed at the MNO's premises. The SIM provisioning and deprovisioning messenger 111 resides on the MNO's network and provides a means of communicating securely with a subscriber's mobile device 105. The SIM provisioning and de-provisioning messenger 111 may be used to install and uninstall (U)SAT applications, such as the (U)SAT application 108.

The SIM messenger 111 interacts with the (U)SIM of the mobile device 105 via the radio interface 107 and with a SIM messenger interface 121 of an IDP 120. The SIM messenger interface 121 provides administrative and transaction functions and is generally referred to herein as a SIM administration and transaction messenger. The (U)SAT application 108 may be able to communicate directly with the SIM administration and transaction messenger 121. The SIM administration and transaction messenger 121 is a server application that is installed at the IDP 120. The IDP 120 may itself be hosted at the premises of the ASP 140. The ASP 140 may use one SIM administration and transaction messenger 121 for more than one IDP.

The SIM provisioning and de-provisioning messenger 111 and the SIMadministration and transaction messenger 121 implement a secure connection with the mobile device 105, and therefore the UICC 106 and (U)SAT application 108, for example using the Internet Protocol (IP), Short Messaging Service (SMS) or another transport-based protocol.

In some examples, the (U)SAT application 108 is delivered to the mobile device 105 Over The Air (OTA) by the MNO 110 via the radio interface 107. In such embodiments, consideration should ideally be given to the size of the (U)SAT application 108 during its development in order to minimise the payload and network traffic involved in delivering the (U)SAT application 108 to the mobile device 105. In other embodiments, the (U)SAT application 108 is installed on the UICC 106 by the MNO 110 prior to dispatch of the UICC 106 to the user. Updates to the (U)SAT application 108 may be delivered to the mobile device 105 over the radio interface 107.

In some examples, the MNO 110 includes a subscriber store 113. The subscriber store 113 is a database that stores personal information relating to a mobile phone account holder, such as full name, address, mobile phone number (MSISDN), registered payment instrument etc. The personal information in the subscriber store 113 may be used to provide the information to register a subscriber to an IDP 120 and, therefore, the ASP 140.

The MNO 110 includes operations systems 114 which may be a collection of services that enable the monitoring of key metrics that may be used by the MNO 110 to gather relevant information on the activities of one or more given users, such as the number and type of transactions performed over a given period of time.

The MNO 110 includes an IDP interface layer 112 which may be supplied to the MNO 110 by the ASP 140 in the form of a hardware appliance that consists of a set of cryptographic keys (to enable secure communications with the IDP 120) and web services. The web services may be invoked by the various systems or invoke services in the systems of the MNO 110. As an example, a service may include the ability to copy data from the subscriber store 113 to form the basis of a profile of a subscriber in the IDP 120.

The exemplary system includes an authorization provider, which, in this example, is a computing system, comprising for example one or more servers and data storage devices, referred to herein as an Identity Provider (IDP) 120. The IDP 120 is responsible for, amongst other things, issuing a subscriber ID to a user and maintaining a database of the user's credentials (name, address, credit or other payment card details and the like). In some examples, a master subscriber ID store 152 is maintained by the ASP 140 to keep a record of all subscriber IDs issued by every IDP 120. Whenever an IDP 120 wishes to issue a new subscriber ID, it checks with the subscriber ID store 152 to ensure that the desired subscriber ID is available.

The IDP 120 may be connected to the MNO 110 by means of a private-circuit services network (for example by using a leased line), a public network such as the Internet (for example via an Asymmetric Digital Subscriber Line (ADSL) connection) or the like.

The IDP 120 includes the SIM administration and transaction messenger 121 and a Consumer Management Portal (CMP) 122 that communicates with a Consumer Management Database (CMD) 123. The IDP 120 also includes an ASP interface 124 which allows the IDP 120 to communicate with the ASP 140.

The SIM administration and transaction messenger 121 allows the IDP 120 to communicate directly with the mobile device 105 and the (U)SAT application 108 via the radio interface 109.

The (U)SAT application 108 interprets requests and data sent by the IDP 120 via the SIM administration and transaction messenger 121. In general, such data corresponds to text to be displayed on a display screen of the mobile device 105 during transaction authentication and authorization.

In use, the (U)SAT application 108 may prompt the subscriber for an authorization decision to respond to requests from the IDP 120. If the subscriber attempts to accept the authorization, then they first positively authenticate to the 25(U)SAT application 108 and then select a payment card instrument and/or delivery address from a list provided to the (U)SAT application 108 by the IDP 120. The (U)SAT application 108 then responds to the IDP 120 with the subscriber's choices, including an authorization decision (for example, Accept, Decline or Report Fraud) as well as payment card and/or delivery address selected. If the subscriber fails to authenticate positively for a predetermined number of attempts in a row, the (U)SAT application 108 is locked until the subscriber successfully resets the (U)SAT application 108 by performing a (U)SAT application 108 authentication reset process.

For any transaction requests made by the IDP 120 while the (U)SAT application 108 is in the locked state, the subscriber can be reminded to unlock the (U)SAT application 108.

In some examples, the CMP 122 comprises a user interface in the form of a web application. The user can access the CMP 122 via the browser 101 of their computing device 100. In some embodiments, the CMP 122 may comprise a user interface in another form, such as another application, for example a mobile application. The CMP 122 is capable of writing data to, and retrieving data from, the CMD 123 and interfaces with the ASP 140 via the ASP interface 124, to enable subscribers to select their subscriber ID at sign-up.

In some examples, the user interface of the CMP 122 is customisable by the IDP 120. The CMP 122 may be customisable, for example so that the IDP 120 can apply its own branding and/or style to the CMP 122. Secure HyperText Transfer Protocol (HTTPS) may be used, in some embodiments, for subscriber interactions with the CMP 122 when sensitive information is being transferred.

The CMD 123 is a database and serves as a credential vault for subscribers. The CMP 122 can access the CMD 123 to store and retrieve subscriber data. The CMD 123 may be a relational or a non-relational database. The CMD 123 may be installed at the IDP's premises.

The ASP interface 124 enables the IDP 120 to interact with the ASP 140. The ASP interface 124 may be installed at the IDP's premises. The IDP 120 uses the ASP interface 124 to interface with the ASP 140. The ASP interface 124 interacts with the ASP 140 to enable transaction requests and responses from a CSP 130 to be authorized by a subscriber. The IDP 120 may be connected to the ASP 140 by means of a private-circuit services network (for example by using a leased line), a public network such as the Internet (for example via an ADSL connection) or the like.

The MNO interface 127 enables the IDP 120 to communicate with the MNO's various systems, including the mobile device 105, via the SIM provisioning and de-provisioning messenger 111 (via the IDP Interface 112). The system depicted in FIG. 1 includes a plurality of relying parties. In this example, a relying party is a computing system, comprising for example one or more servers and data storage devices, referred to herein as a Consumer Service Provider (CSP) 130. The CSP 130 may be, for example, an online merchant computing system. The CSP 130 includes a presentation layer 131 for interacting with the subscriber and an ASP interface 132 for communications with the ASP 140.

In some examples, the presentation layer 131 is a web component that may be incorporated into a CSP's existing website by the CSP 130. In this example, the CSP 130 is an online retailer with a website that incorporates the presentation layer 131. The subscriber interacts with the presentation layer 131 via the browser 101 in their computing device 100. The presentation layer 131 uses the ASP interface 132 of the CSP 130 to exchange messages with the ASP 140. In some examples, the presentation layer 131 is designed for ease-of-integration in the website of the CSP 130, so that it can be added to the CSP's existing website with minimal development effort.

The presentation layer 131 interacts with a CSP security and configuration module 133. The CSP security and configuration module 133 may be a pre-packaged software module that is issued to each CSP 130 by the ASP 140 at the time of CSP 130's sign up. The CSP security and configuration module 133 includes relevant cryptographic keys to enable secure communications with the ASP 140 via the ASP interface 132 for an application 102 or directly via the browser 101. The CSP security and configuration module 133 may be unique to each CSP 130. The CSP security and configuration module 133 may comprise:

Private element (PRC_{c}) of asymmetric key pair that is unique to the CSP 130, used to decrypt confidential messages (via an asymmetric cipher algorithm, such as RSA or ECC) and securely exchange symmetric cryptographic key material sent by ASP 140, which uses the corresponding public asymmetric key element; and

Public element (PUA_{c}) of asymmetric key pair unique to the ASP 140, used to sign messages (via an asymmetric cipher algorithm, such as RSA or ECC) sent by ASP 140, which uses the corresponding private asymmetric key element.

In some examples, the subscriber may be able to interact with the presentation layer 131 via the application 102 in their computing device 100. The presentation layer 131 uses the ASP interface 132 of the CSP 130 to exchange messages with the ASP 140. The messages may be secure messages. The presentation layer 131 may include a package of application-specific code such as Objective-C. In some embodiments, the presentation layer 131 is designed for easeof-integration in the application 102 of the CSP 130, so that it can be added to the CSP's existing application 102 with minimal development effort.

The ASP interface 132 is an interface layer that is used by the presentation layer 131 to interface with the ASP 140. As described above, the CSP security and configuration module 133 enables the CSP 130 to communicate securely with the ASP 140, either via the browser 101 or via the ASP interface 132.

The ASP 140 may be a computing system, comprising for example one or more servers and data storage devices, referred to herein as an authorization platform which is responsible for controlling authorization and information exchange services and interfacing with the various different entities involved.

The ASP 140 includes a CSP presentation layer 184 which is a web component that may be incorporated into a CSP's website by the CSP 130. In this example, the CSP 130 is an online retailer with a website that interacts with the CSP security and configuration module 133. The subscriber interacts with the CSP presentation layer 184 via the web browser 101 in their computing device 100. The CSP presentation layer 184 uses the subscriber's web browser to interact securely with the CSP 130 to exchange messages with the ASP 140. In some embodiments, the CSP presentation layer 184 is designed for ease-of-integration in the website of the CSP 130, so that it can be added to the CSP's existing website with minimal development effort. The CSP presentation layer 184 may include a package of HyperText Markup Language (HTML), Cascading Style Sheets (CSS) or JavaScript code.

The ASP 140 includes an IDP interface 141 which provides an interface to and from the IDP 120, a CSP interface 142 which provides an interface to and from the CSP 130, an MA interface 143 which provides an interface to and from the MA 160, a CRA interface 144 which provides an interface to and from the CRA 170, a PSP interface 145 which provides an interface to and from the PSP 180 and a CI interface 146 which provides an interface to and from the CI 190.

The ASP 140 further includes an engine 147, referred to herein as a workflow engine 147, which controls message routing and orchestrations within the ASP 140. The ASP 140 further includes a transaction archive 149, which stores transaction details. The ASP 140 further includes an engine 148, referred to herein as an audit, account and report engine 148, which records and reports transaction information for regulatory and contractual compliance requirements. The ADP 140 further includes an engine 154, referred to herein as a billing engine 154, which generates invoices. The ASP 140 further includes an engine 155, referred to herein as a fraud risk and policy detection engine 155, which may be able to detect fraudulent activity by monitoring and controlling the velocity and volume of transactions undertaken by individual subscribers and CSPs. The ASP further includes a subscriber ID Hot File List (HFL) 156 which records compromised subscriber IDs. The ASP 140 further includes an interface 157, referred to herein as a platform administration portal 157.

The IDP interface 141 is an interface that forms part of the ASP 140. In some embodiments, the IDP interface 141 is operable to handle communications with a plurality of IDPs (one of which is shown as being IDP 120), via respective ASPinterfaces (one of which is shown as being ASP interface 124 of the IDP 120). In some embodiments, the IDPs may be hosted (run and maintained as a managed service) on the same platform as the ASP 140 to enable greater flexibility and agility when changes may need to be made to the IDP environment. The IDP interface 141 passes messages to and from the workflow engine 147 of the ASP 140.

The IDP interface 141 is a set of web services which reside within the ASP 140 and which provides services to IDPs 120.

The CSP interface 142 is an interface that forms part of the ASP 140. In some embodiments, the CSP interface 142 is operable to handle communications with several, different CSPs (one of which is shown as being CSP 130) and to send messages to, and receive messages from, the ASP interfaces of the CSPs 130 (one of which is shown to be the ASP interface 132), which may be integrated into the CSP's website.

The CSP interface 142 is a set of web services which reside within the ASP 140 and which provides services to the CSP 130, in particular for back-end based communications when the application 102 is used as the interface by the subscriber. In some embodiments, when information is received at the ASP 140 via the CSP presentation layer 184 or the CSP interface 142, a check is made that the request has originated from a valid CSP 130 by ensuring that the CSP 130 has used the appropriate cryptographic keys from its unique CSP security and configuration module 133 and that the CSP's account with the ASP 140 is enabled.

The MA interface 143 is an interface (or series of interfaces) to various Mas (one of which is shown as being MA 160). The ASP 140 may be connected to the MA 160 via the MA interface 143 by means of a private-circuit services network (for example by using a leased line), a public network such as the Internet (for example via an ADSL connection) or the like. The MA interface 143 may be configured to exchange data with the MA 160 via the MA's API 145 using the MA's preferred communications protocol. The MA interface 143 is arranged to communicate with the workflow engine 147 of the ASP 140. The MA interface 143 provides a gateway to the MA 160 and enables the ASP 140 to process payments on behalf of the CSP 130. For example, the MA interface 143 enables workflow agents to complete a CNP transaction for payment or a pre-authorization to confirm a subscriber's identity as part of the initial Know Your Customer (KYC) process.

The CRA interface 144 is an interface (or series of interfaces) to various CRAs (one of which is shown as CRA 170). The ASP 140 may be connected to the CRA 170 via the CRA interface 144 by means of a private-circuit services network (for example by using a leased line), a public network such as the Internet (for example via an ADSL connection) or the like. The CRA interface 144 may be configured to exchange data with the CRA 170 via the CRA's API 175 using the CRA's preferred communications protocol. The CRA interface 144 is arranged to communicate with the workflow engine 147 of the ASP 140.

The PSP interface 145 is an interface (or series of interfaces) to various PSPs (one of which is shown as PSP 180). The ASP 140 may be connected to the PSP 180 via the PSP interface 145 by means of a private-circuit services network (for example by using a leased line), a public network such as the Internet (for example via an ADSL connection) or the like.

The PSP interface 145 may be configured to exchange data with the PSP 180 via the PSP's API 185 using the PSP's preferred communications protocol. The PSP interface 145 is arranged to communicate with the workflow engine 147 of the ASP 140.

The PSP interface 145 is used, for example, to provide the PSP 180 with instructions to generate paper invoices as part of a billing cycle and for postal (physical or virtual) communications to subscribers, for example as part of an initial KYC process. The PSP interface 145 may be used, for example, to call a function via the PSP API 185 to:

send an activation PIN to a subscriber via physical or virtual post as part of the initial registration procedure;

send a physical invoice via post to CSPs 130; and

send a physical payment slip via post to an IDP 120.

The PSP's API 185 may offer a secure capability for generating and delivering activation PINs. The PSP interface 145 may handle data transformation required by the PSP's API 185. The PSP interface 145 may implement API calls to the PSP as determined by the PSP's API specification. The PSP API 185 may comprise a single function call that sends content (for example, a Portable Document Format (PDF) or eXtensible Markup Language (XML) file) and envelope or subscriber ID details to the PSP 180 and receives a status code in response, which is passed to the entity making the call.

The CI interface 146 is an interface (or series of interfaces) to various CIs (one of which is shown as CI 190). The ASP 140 may be connected to the PSP 190 via the PSP interface 146 by means of a private-circuit services network (for example by using a leased line), a public network such as the Internet (for example via ADSL connection) or the like. The CI interface 146 may be configured to exchange data with the CI 190 via the CI's API 195 using the CI's preferred communications protocol. The CI interface 146 is arranged to communicate with the workflow engine 147 of the ASP 140.

The transaction archive 149 comprises a high-volume data store for all end-to-end transactions passing through, or processed by, the ASP 140. The transaction archive 149 may be used to associate transactions with subscriber IDs, IDPs 120, CSPs 130, MAs 160, CRAs 170, PSPs 180 and/or CIs 190.

In some examples, the transaction archive 149 is optimised for write-access. For example, if the transaction archive 149 is mainly required for infrequent analysis, such as transaction disputes or bill calculation, then read access may not be particularly time-sensitive. In such examples, transactions may be stored in an inmemory database and then offloaded periodically for archiving. In such examples, operation of the ASP 140 need not be unduly hindered by the need to record transactional information in the transaction archive 149.

The workflow engine 147 enables end-to-end authentication processes to be defined using interfaces and orchestrated services. Since an initial KYC process may involve sending a physical or virtual postal communication to the subscriber (for example by means of a PSP 180), the workflow engine 147 may be capable of handling asynchronous transactions with potentially lengthy delays between stages.

The workflow engine 147 implements particular transactions. For instance, a CNP payment transaction involves a level of interaction between the CSP 130 requesting the CNP payment, the ASP 140, the IDP 120 and potentially the MA 160, via a MA security and configuration module 166. The MA security and configuration module 166 is a pre-packed software module provided to the MA 160 by the ASP 140.

The MA security and configuration module 166 may comprise:

Private element (PRMC) of asymmetric key pair that is unique to the MA 160, used to decrypt confidential messages (via an asymmetric cipher algorithm, such as RSA or ECC) and securely exchange symmetric cryptographic key material sent by ASP 140, which uses the corresponding public asymmetric key element; and

Public element (PUAC) of asymmetric key pair unique to the ASP 140, used to sign messages (via an asymmetric cipher algorithm, such as RSA or ECC) sent by ASP 140, which uses the corresponding private asymmetric key element.

The MA 160 is involved if the CSP 130 has requested the MA 160 to process CNP payment transactions on its behalf. For example, some websites use a hosted payment page to avoid handling payment instrument details and the associated compliance requirements (e.g. Payment Card Industry Data Security Standard—PCI DSS). This means that the ASP 140 may be required to package payment card data to be used by the CSP 130's MA 160 to process CNP payments. This data would be passed on by the CSP 130, but would be encrypted using the Public element (PUMC) of the asymmetric key pair that is unique to the MA 160 and issued by the ASP 140. In this instance, the ASP 140 would provide the CSP 130 with an encrypted data packet (including the payment instrument details such as name, card number, expiry date etc.) using the Public element (PUMC). This would then be passed on to its MA 160, by the CSP 130, along with the transaction amount by the CSP 130. The MA 160 would then decrypt the data packet using the Private element (PRMC). The MA 160 would then process the payment and pass back the result to the CSP 130. This process enables both the CSP 130 and MA 160 to continue to authorize and settle CNP payment transactions directly with minimal additional effort. The workflow engine 147 is responsible for coordinating these interactions, where a workflow agent may be defined for each transaction type and new workflow agents may also be defined for as yet undefined workflows where a subscriber's authorization is required to perform transactions and exchange information with a CSP 130.

A workflow agent may carry out the tasks below:

set the transaction status in the transaction archive 149 to ‘In Progress’;

pass the transaction object or request to the fraud and risk policy engine 155 for validation:
if the validation is not successful, fail the transaction and aborting processing;
execute the logic of the transaction;
update the transaction status throughout the processing of the transaction; and
provide updates in relation to the transaction to the transaction archive 149.

The audit, account and report engine 148 is a mirrored copy of the transaction archive 149, that is used for reporting, compliance and fraud purposes. The data in the audit, account and report engine 148 may be slightly older than that in the transaction archive 149 (for example, delayed by a few hours). The audit, account and report engine 148 may be used as part of a periodic, for example weekly or monthly, billing cycle by the billing engine 154.

The audit, account and report engine 148 may also be used to monitor and analyze transactions recorded in the transaction archive 149 for general administrative and fraud-prevention purposes. The audit, account and report engine 148 may be used to provide pre-defined reports for business and management intelligence, including, for example, for IDPs 120 and CSPs 130.

The billing engine 154 generates invoices for CSPs 130 and other invoices for IDPs to whom money may be owed by the ASP 140.

The fraud and risk policy engine 155 acts as a real-time analytics and rules engine that can be used to deny (suspected) fraudulent activity or transactions based on velocity (for example no more than two transactions per subscriber per minute or inability to use new international delivery addresses for 24 hours) and volume rules (for example no more than three delivery addresses can be added per day) or other business intelligence. The anti-fraud rules or business intelligence may be defined by the ASP 140, the IDP 120, CSP 130 or the subscriber.

Workflow agents may pass transaction requests for a transaction to the fraud and risk policy engine 155 for validation before processing the transaction. The fraud and risk policy engine 155 may return a ‘pass’ or ‘fail’ result. If a transaction fails the anti-fraud and risk policy processing, it is aborted by the workflow agent and the transaction status in the transaction archive 149 is set to ‘Fraudulent’.

The fraud and risk policy engine 155 may provide a modular system whereby rules can be added and hot-deployed. An interface may be provided by means of which new rules can be defined and/or existing rules can be modified. Rules are provided with the full details of the transaction as input and return a ‘pass’ answer, or a ‘fail’ answer, along with an error code giving further information as to why the transaction was failed.

To block subscriber IDs and/or accounts which are known to be compromised, an ID Hot File List (HFL) 156 may be provided. The HFL 156 is a centralized list or database maintained by the ASP 140 and which is populated based upon information provided by each subscriber, IDP 120 or CSP 130.

The ASP 140 includes a CSP configuration store 182 primarily stores information pertaining to the CSP 130 and its account with the ASP 140. The CSP 130 may register and maintain an account with the CSP configuration store 182 through a CSP registration and administration portal 183, which is a browser-based user interface. The CSP registration and administration portal 183 may also be used by the CSP 130 to set preferences, such as which payment instruments it may (or may not) accept or to which countries it may ship merchandise. For certain payment transactions (for example Visa and MasterCard but not Amex), this may then result in only offering those accepted options to the customer, such as only displaying registered Visa and MasterCard payment options and not Amex and from a delivery perspective only offering those deliver addresses registered in the US and UK.

The ASP 140 includes a CSP cryptographic store 181, which primarily stores asymmetric cryptographic keys (2048-bit RSA or 224-bit ECC) for each CSP 130. These keys are used to secure the confidentiality, integrity and authenticity of communications between the ASP 140 and the CSP 130.

The CSP presentation layer 184 is a web services API which may be invoked by the subscriber's computing device 100 (via the browser 101) to connect dynamically the subscriber's browser to the ASP 140 and download any necessary web component, such as an iFrame, to enable the subscriber to enter their subscriber ID to initiate a transaction.

The platform administrative portal 157 is a browser-based user interface to the ASP 140 which allows interaction with, and maintenance of, the ASP 140 and, generally, the authorization and information exchange service.

To preserve a subscriber's privacy, the concept of pseudonym IDs, an ID that can be used to try to conceal the subscriber's subscriber ID, may be applied. In such cases, a subscriber is assigned an individual, unique pseudonym ID (for example by the IDP 120) in respect of each different CSP 130 with which they transact. A pseudonym ID reduces the likelihood that a group of CSPs 130 could collude and track a subscriber's behaviour by tracking a particular subscriber's subscriber ID.

The ASP 140 may be arranged not to store any Personally Identifiable Information (PII) pertaining to a particular subscriber. However, since PII is processed and transmitted via the ASP 140, to maintain security best practices, the ASP 140 may be configured only to handle and share PII for which the subscriber has explicitly provided consent, through a message authorization. Furthermore, all PII may be encrypted whenever it is transit or storage.

In some examples, PII is only stored in the CMD 123 of the IDP 120 and by CSPs 130 (for targeted marketing purposes). In such examples, the transaction archive 149 may be arranged only to store normalised transaction information, for example pseudonym IDs, transaction type and basic transaction data; not name, address or even the subscriber's subscriber ID.

In some examples, the mobile device 105 includes a touch-sensitive display screen 103 which is operable to output data from the (U)SAT application 108 for visual display to the subscriber and to receive data input from the subscriber into the (U)SAT application 108. The display screen may display a user interface 104 by means of which the subscriber can interact with the (U)SAT application 108.

The user interface 104 may include a dialog region which may identify the transaction authorization and information exchange service provider and/or the IDP 120, for example by displaying their name and/or logo along with other optional descriptive text.

The user interface 104 may also include a transaction description region in which details of a transaction for which authorization is sought can be provided. Providing such details of the transaction assists a subscriber in determining how to respond to the authorization request.

The user interface 104 may further include a selection menu region, which may be in the form of a drop-down selection menu, a spinner menu or the like. The selection menu may provide the subscriber with several options from which the subscriber may select one (or in some embodiments more than one) option.

For example, the selection menu may identify a plurality of payment instruments or shipping addresses associated with the subscriber that could be used to make a CNP payment and ship merchandise, from which the subscriber can select a particular payment card for a CNP payment transaction and shipping address. In some situations, the interface 104 may not display the selection menu, for example during initial registration of the consumer to the authorization and information exchange service.

The interface 104 may further include a PIN entry region into which the subscriber can enter a secret PIN number. The secret PIN number may be used to authenticate the subscriber. In some examples, the PIN entry region may, instead, be capable of receiving an alphanumeric input from the subscriber, for example if the (U)SAT application 108 requires the subscriber to input a secret password in the form of an alphanumeric string for the purposes of authentication. In some examples, the authentication entry may, instead, be capable of receiving a biometric input from the subscriber, for example if the (U)SAT application 108 requires the subscriber to input their fingerprint or retina for the purposes of authentication.

The interface 104 may further include authorization options which may be used to provide additional input to the (U)SAT application 108. For example, the authorization options may be used to accept or decline a transaction or report the transaction as being fraudulent.

The IDP and/or authorization service and information exchange providers' names may be delivered to the mobile device 105 from the IDP 120 or may be hardcoded in the (U)SAT application 108. In some embodiments, the IDP and/or authorization and information exchange service providers' names may be sent to the mobile device 105 each time a transaction authorization is sought.

The descriptive text for display in the transaction description region, information for the selection menu, authorization options and any other text or content for display on the interface may also be provided to the mobile device 105 each time a transaction authorization is sought. In such examples, the text for display on the interface 104 can be modified at the IDP 120 and transmitted to the mobile device 105 when required.

In some examples, a PIN entered via the PIN entry region is validatedlocally (or offline) by the (U)SAT application 108. In such examples, the (U)SATapplication 108 receives the PIN input by the subscriber (or registering user), compares the input PIN with a reference PIN for authenticating the subscriber and determines itself whether the PINs match and, accordingly, whether the subscriber has successfully authenticated themselves. This may improve efficiency and security since the subscriber's secret PIN for authorizing transactions is not transmitted over the air between the ASP 140 and the mobile device 105.

In some examples, in the event that the subscriber incorrectly enters a PIN, the (U)SAT application 108 increments a local counter. After a predetermined number of failed attempts, for example after three or five successive failed attempts, the (U)SAT application 108 locks and may display an appropriate message to the subscriber, for example in the transaction description region. The (U)SAT application 108 may send a lockout message to the IDP 120 by making a PIN Attempts Exceeded function call of the IDP 120. Calling the ‘PIN Attempts Exceeded’ function may trigger the IDP 120 to send a message to the CMD 123 to lockout (temporarily or permanently disable) the subscriber's account and/or subscriber ID. Additionally, a locked subscriber ID may be added to the HFL 156.

Following a lockout of the subscriber's account, an automatic reset of the PIN and (U)SAT application 108 by an appropriate Over The Air (OTA) command may be invoked. To make further use of the (U)SAT application 108 and, therefore, the ASP 140 service, the subscriber calls a pre-defined number for their IDP 120 to prove their identity. Following this, a new temporary PIN may be sent to the subscriber via post (physical or virtual), where the reset (U)SAT application 108 may only accept the new temporary PIN. Upon receipt of the new temporary PIN, the subscriber may access the (U)SAT application 108, and follows PIN reset instructions which may be displayed in the transaction description region of the display screen 302.

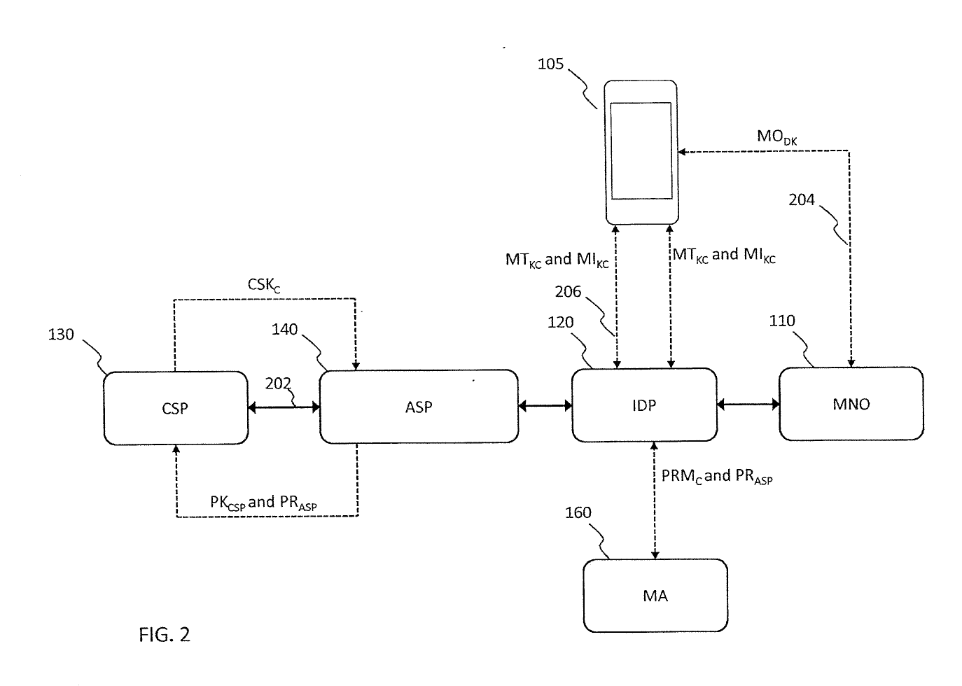

The subscriber may be prompted to input the new temporary PIN to the PIN entry region and, if the input PIN matches the new temporary PIN stored at the mobile device 105, the subscriber is prompted to set a new secret PIN by entering it twice in the PIN entry region. In some examples, the subscriber may only be able to attempt to enter the new temporary PIN three times before the (U)SAT application 108 again locks out FIG. 2 shows an overview of exemplary security architectures in place between the mobile device 105, the IDP 120, the ASP 140 and the CSP 130.

In some examples, to enhance data security, all communications between the mobile device 105, the IDP 120, the ASP 140 and the CSP 130 are digitally signed, using appropriate cryptographic mechanisms. This preserves the confidentiality and integrity of the communications as well as providing nonrepudiation. In addition, all communications between the ASP 140 and third parties, such as MAs 160, CRAs 170, PSPs 180 and CIs 190 may be encrypted using Secure Session Layer (SSL) techniques implementing, as a minimum, 256-bit symmetric key cryptography, 2048-bit RSA asymmetric key cryptography or 224-bit ECC asymmetric key cryptography.

In some examples, communications 202 from the ASP 140 to the CSP 130, which may be via the computing device 100, are secured by 2048-bit RSA (or 224-bit ECC) asymmetric key:
the ASP's public key element (PK_{ASP}) is provided to the CSP 130 via the CSP registration and administration portal 183 to ensure that communications are authentic, with the corresponding private key element (PR_{ASP}) used by the ASP 140 to digitally sign communications with the CSP 130;
the CSP's private key element (PR_{csp}) is provided to the CSP 130 at its time of registration with the ASP 140 to ensure communications are confidential, with the corresponding public key element (PKcsp) used by the ASP 140 to communicate with the CSP 130; and
a unique symmetric key (CSK) (e.g. 256-bit AES cryptography) may be exchanged between the ASP 140 and CSP 130 to securely communicate on a per transaction request/response basis.

In some examples, communications 204 from the MNO 110 to the mobile device 105 are secured by symmetric (or asymmetric) cryptographic techniques, whereby the provisioning key (MO_{DK}—symmetric or private element of asymmetric pair) may be placed in the (U)SAT application 108 at manufacture and, therefore, delivered as part of the initial (U)SAT application 108, which may be injected into the (U)SIM by the SIM messenger 111.

In some examples, following the initial provisioning process, a set of unique cryptographic keys including, administration (MAK_{c}), transaction (MTK_{c}) and integrity check (MIK_{c}) may be injected into the (U)SAT application 108 by the SIM administration and transaction messenger 121 using the provisioning key MO_{DK}. Additionally, a set of counters, including an administration counter (C_{A}) and a transaction counter (C_{T}) may be injected into the (U)SAT application 108, by the SIM administration and transaction messenger 121 using the provisioning key MO_{DK}.

The administration key (MAK_{C}) may be used to protect the confidentiality of administration tasks, such as update of cryptographic keys, anti-replay counters, application features etc. The transaction key (MTK_{C}) may be used to protect the confidentiality of all transaction information, such as authorization requests and responses. The integrity check key (MIK_{C}) may be used to protect the integrity of all communications using a Message Authentication Code (MAC), such as SHA-1. The administration counter (C_{A}) may be used to protect against replay attacks on the administration channel, and the transaction counter (CT) may be used to protect against replay attacks on the transaction channel. Communications 206 between the IDP 120 and the mobile device 105 are secured by using the MAK_{C}, MTK_{c} and MIK_{C}, cryptographic keys, in combination with the anti-replay counters C_{A} and C_{T}.

As an additional control, IP address restriction may be used to restrict communications to certain predetermined IP addresses.

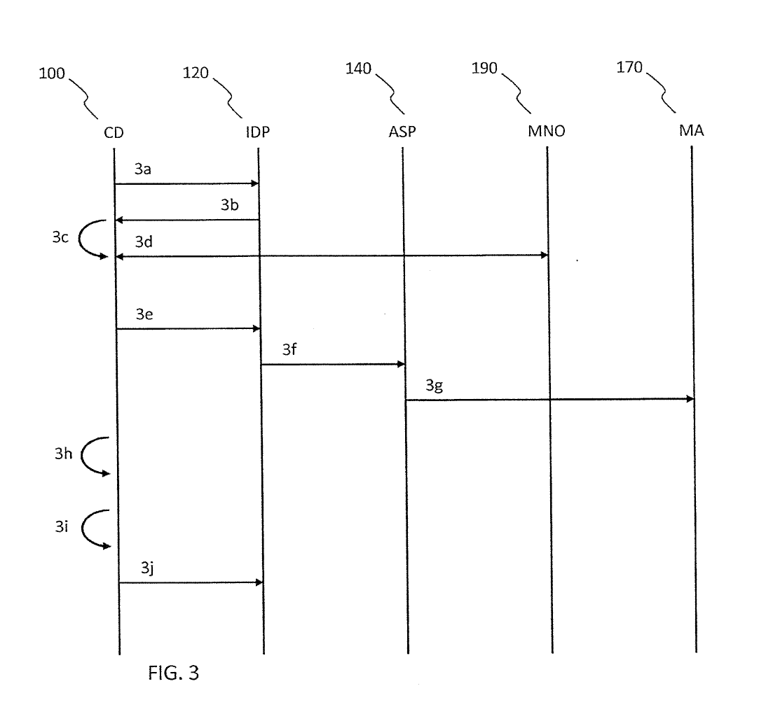

FIG. 3 is a sequence diagram of an exemplary registration procedure in which a registering user wishes to subscribe to the ASP 140.

At steps 3a and 3b, a user that wishes to register for the authorization service uses the browser 101 of their computing device 100 to request and retrieve a registration page of an IDP's website. The browser 101 displays the registration page to the user.

At step 3c, the registering user is prompted to select a subscriber ID for the authorization and information exchange service and provide basic personal information, which is known by their MNO 110 (for example mobile device number, full name, address, date of birth, amount of last mobile phone bill and date of mobile phone account opening).

At step 3d, the registering user's details are validated with the MNO's 110 subscriber store 113 via the IDP interface 112. A user is deemed to be automatically verified with no need for additional KYC checks if:

1. the basic personal information provided matches that on record with the MNO's 110 subscriber store 113;

2. the user agrees to the name on the account;

3. the user has held an account with their MNO 110 for greater than a period (for example 6 months) that is agreed between the MNO 110 and the ASP 140;

4. the user has paid their bills on time using the same payment instrument with no repudiation; and

5. the user agrees to the address on the account.

At step 3e if the registering user does not satisfy the first condition then they are prompted again for the basic personal information again. Similarly, if the user does not satisfy the second condition then they are prompted to first change these details with their MNO 110. If the user provides the correct basic personal information but does not satisfy both of the following conditions then they may be required to undergo additional verification that is to provide the details (card PAN number, expiry and security code) of a payment instrument registered at the same address as their mobile phone account. This uses the fact that the registering user has passed strict AML (Anti-Money Laundering) KYC checks imposed by payment instrument issuing institutions and the Address Verification Scheme (AVS).

At step 3f the IDP 120 provides the ASP 140 with the payment instrument and address information for the user.

At step 3g the ASP 140 credits a random number (for example two) of payments, via the MA interface 143, with arbitrary transaction reference codes,

At step 3h the registering user returns to the CMA 126 to prove knowledge of the amount(s) credited along with the corresponding transaction reference codes. If the details provided are correct then the user is deemed to be verified.

The validation of steps 3d to 3h may take place using background web service calls (not shown). For example, the registering user may be prompted to input a desired subscriber ID for the transaction authorization and information exchange service. A background web service call may determine whether the desired subscriber ID is available. In some examples, when the registering user inputs a desired subscriber ID, a call is made to the subscriber ID store 152 to determine whether the registering user's desired subscriber ID is available. If the registering user's desired subscriber ID is not available, the registering user is presented with a list of alternative subscriber IDs that are available.

At step 3i, the registering user may then augment their profile (on the CMD 123) with additional information elements, such as passport number(s), driving license number(s) as well as payment instrument and shipping address details. These elements may be assigned memorable, user-friendly names for each of their payment instruments and shipping addresses. If the registering user does assign such user-friendly names, the user-friendly name for the cards and addresses is shown on the handset during the transaction authorization procedure. The registering user may register more than one payment instrument and shipping address against their account. A check is be performed with the fraud and risk policy engine 155 to ensure that any shipping address added is not on a watch list of fraudulent addresses.

At step 3j, the registering user's details and subscriber ID are transmitted from the computing device 100 to the IDP 120.

When the registering user's record is created in the CMD 123 but the user has not yet been verified, their status is set to indicate that they have not yet passed the full initial KYC (payment credited on account) check. The registering user's status may be updated during later stages of the registration process, for example following successful completion.

In some cases, the registering user may cancel registration rather than completing their registration. In such cases the registering user's record 300 may be removed from the CMD 123.

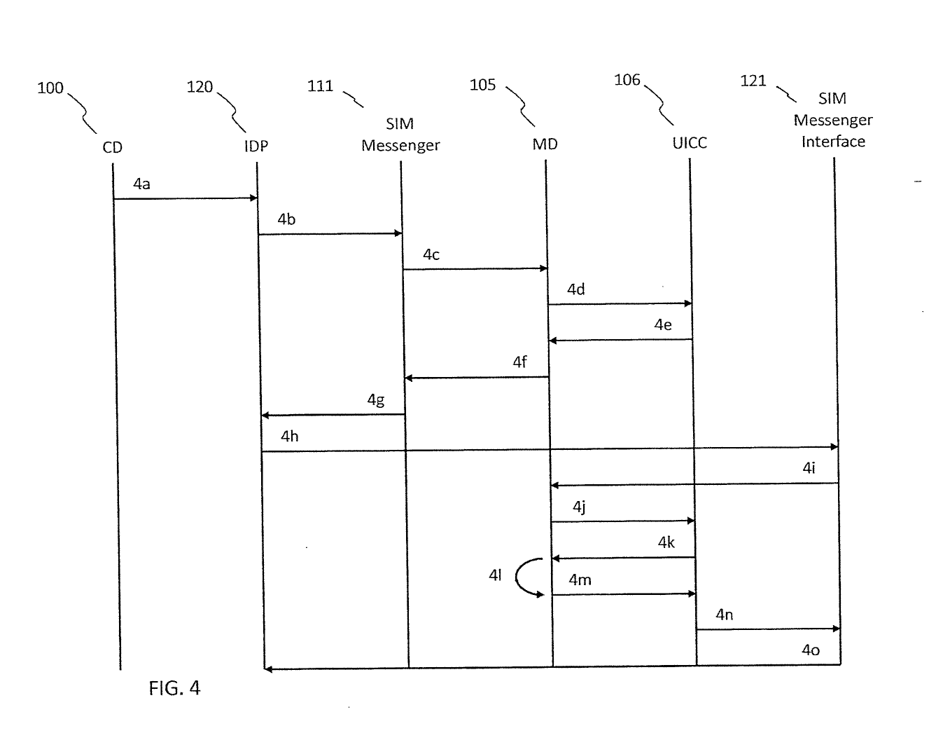

FIG. 4 is a sequence diagram of an exemplary registration completion procedure.

Once verified, the registering user completes the registration process by entering their subscriber ID into the CMA 126 (via a browser), in step 4a. The IDP 120 then injects the (U)SAT application 108 into the (U)SIM 106 via the MNO 110, using the SIM provision and de-provision messenger 111 in steps 4b to 4d. Upon successful injection into the (U)SIM 106, the (U)SAT application 108 notifies the SIM provision and de-provision messenger 111 in steps 4e and 4f. In step 4g, the MNO 110 then notifies the IDP 120 of the successful injection. In steps 4h to 4j, the IDP 120 then activates the (U)SAT application 108 itself by interacting with the SIM administration and transaction messenger 121, which injects the set of security credentials required (MAK_{c}, MTK_{c}, MIK_{c} as well as anti-replay counters C_{A} and C_{T}) to operate the (U)SAT application 108. The cryptographic keys (MAK_{C}, MTK_{c} and MIK,) and anti-replay (C_{A} and C_{T}) counters are generated by the ASP 140 and may be stored in the MNO cryptographic store 125. In steps 4k to 4m, the user is prompted, by the mobile device 105, to enter and then confirm a PIN, to personalize the (U)SAT application 108. If the operation in steps 4k to 4m is successful then the subscriber is notified on the mobile device 105 as well as on the CMA 126, via their computing device 100 (not shown). At steps 4n and 4o, the IPD 120 is notified of the result of steps 4k to 4m using the SIM administration and transaction messenger 121. The IDP 120 notifies the ASP 140 of successful completion of the complete registration process, where the subscriber's ID is set to active in the subscriber ID store 152.

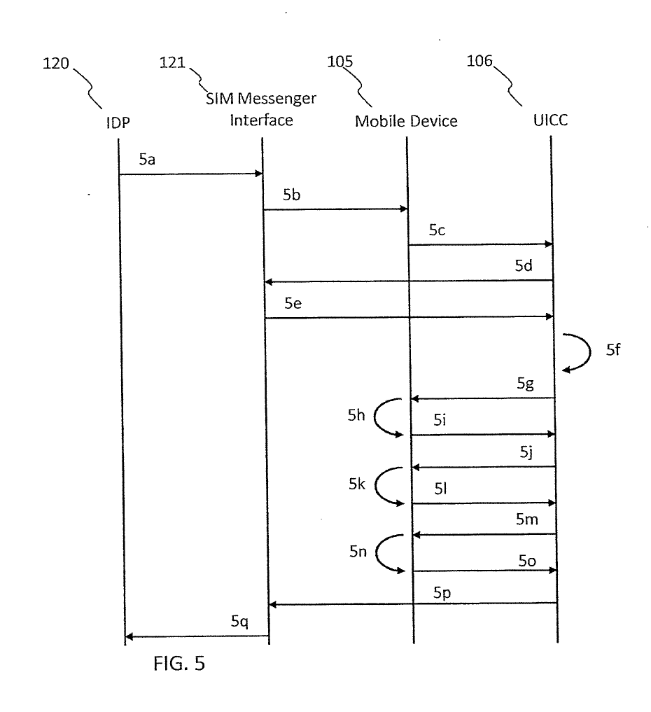

FIG. 5 shows an overview of a transaction authorization request to, and subsequent response from, the (U)SAT application 108.

FIG. 5 shows a wake-up call and acknowledgement (steps 5a to 5d), encryption handshake (steps 5f and 5g) and subsequent transaction authorization response and request (steps 5h and 5i) performed between the SIM messenger 111 of the MNO 110 and the mobile device's (U)SAT application 108.

The (U)SAT application 108 enables the (U)SIM to interact directly with the IDP 120 via the SIM administration and transaction messenger 121 of the IDP 120, via the mobile device 105. The (U)SAT application 108 may provide instructions to, and receive input from, the subscriber via the mobile device 105.

To communicate with the (U)SAT application 108 at the mobile device 105, the IDP 120 instructs the SIM administration and transaction messenger 121 to initiate a wake-up of the (U)SAT application 108, via a Short Messaging Service (SMS) call to the mobile device 105 at steps 5a and 5b. This call may contain a Uniform Resource Locater (URL) for the SIM administration and transaction messenger 121. At step 5c, the mobile device 105 sends the wake-up message to the (U)SAT application 108. At step 5d, the (U)SAT application 108 wakes and may call a pre-defined URL for the SIM administration and transaction messenger 121 or may use the URL specified in the wake-up call. The (U)SAT application 108 may call the URL for the SIM administration and transaction messenger 121 using the Bearer Independent Protocol (BIP). BIP is a protocol between the (U)SAT application 108 and the mobile device 105 which allows the (U)SAT application 108 to access data bearers supported by the mobile device 105. BIP enables the (U)SIM to use the mobile device's high-speed IP-based data bearer capabilities for communications with the MNO 110 via the SIM administration and transaction messenger 121. Such data bearers may include, but are not limited to, General Packet Radio Service (GPRS), Enhanced Data Rates for GSM Evolution (EDGE), or 3G (UMTS) data bearers. Use of the BIP may enable the MNO 110 to deliver services to the (U)SAT application 108 with greater speed, efficiency and with higher reliability than via an SMS channel.

The (U)SAT application 108 may communicate securely with the SIM administration and transaction messenger 121 using the administration (MAK_{C}) or transaction (MTK_{C}) keys for encryption, along with the MIK_{E} for integrity and C_{A} or C_{T} for anti-replay. Mutual authentication is achieved as all keys and counters are kept secret. The high-level communications protocol is as follows:

At step 5e, the SIM administration and transaction messenger 121 generates a request (administrative or transaction) whereby the request payload itself (RQ-PD) along with the counter (C_{A} or C_{T}) are encrypted using an algorithm, such as AES with the key (MAK_{E}, or MTK_{C}). This is then sent along with a Hash Message Authentication Code (MAC) using an algorithm such as SHA-2 Secure Hash Algorithm with the integrity key (MIK_{C}) and the encrypted message derived previously as inputs. The SIM administration and transaction messenger 121 transmits the message to the (U)SAT application 108 which includes the MAC and the encrypted messaged which includes the anti-replay counter.

At step 5f, (U)SAT application 108 verifies the MAC by generating a comparative MAC using the integrity key MIK_{C}, and the encrypted request it received as part of the first element of step 5e as an input into the same SHA-2 Secure Hash Algorithm.

At step 5g, the (U)SAT application 108 instructs the mobile device 105 to prompt the subscriber for their authorization response and the subscriber then inputs their authorization response into the mobile device 105 at step 5h. The authorization response may involve accepting, declining or reporting the transaction as being fraudulent. The mobile device 105 provides the input authorization response to the (U)SAT application 108 at step 5i. If the subscriber accepts the transaction request, then at step 5j the (U)SAT application 108 instructs the mobile device 105 to prompt the subscriber to authenticate themselves, for example by entering a PIN into the (U)SAT application 108 via their mobile device 105, and to authorize the transaction, again by suitable input into their mobile device 105.

The subscriber enters a PIN into the mobile device 105 at step 5k and the mobile device 105 provides the PIN input by the subscriber to the (U)SAT application 108 at step 5l.

If the subscriber successfully authenticates themselves to the (U)SAT application 108, at step 5m, the (U)SAT application 108 instructs the mobile device 105 to prompt the authenticated subscriber to make any additional selections, such as payment instrument and billing address. The subscriber makes their selection(s) on the mobile device 105 at step 5n and the mobile device 105 provides the selection(s) by the subscriber to the (U)SAT application 108 at step 5o.

At step 5p, the (U)SAT application 108 transmits the subscriber's authorization response to the SIM administration and transaction messenger 121. At step 5q, the IDP 120 receives the subscriber's authorization response via the SIM administration and transaction messenger 121.

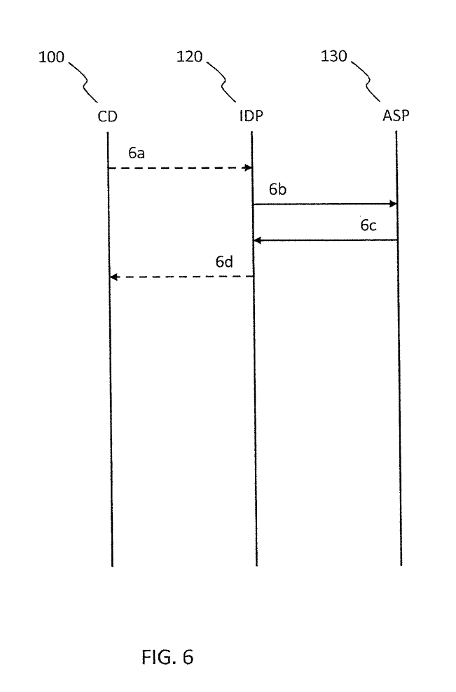

FIG. 6 shows an example of a procedure for placing a compromised subscriber ID into the HFL 156. If a subscriber ID is determined to be compromised, then the subscriber ID is placed on the HFL 156, which is a centralised list of compromised subscriber IDs maintained by the ASP 140.

In the example below, the subscriber has determined that their subscriber ID has been compromised and informs the IDP 120 accordingly via their computing device's browser 101 and the consumer management portal 122. It will be appreciated, however, that the subscriber could inform the IDP 120 of a compromised subscriber ID in a different manner, for example by telephone. Furthermore, an entity other than the subscriber (for example the ASP 140) may inform the IDP 120 that the subscriber ID may be compromised.

At step 6a, the subscriber informs the IDP 120 via their computing device 100 that their subscriber ID may be compromised. For example, the subscriber may inform the MNO 110 that their mobile device 105 has been lost or stolen (“notification”), that subscriber has repudiated a transaction as being fraudulent (“repudiation”) or that the subscriber reported a transaction as being fraudulent during (negative) authorization of the transaction (“report”).

In the event that the subscriber's information of step 6a was in the form of a ‘notification’ or ‘repudiation’, the IDP 120 calls the ASP 140 at step 6b requesting that the compromised subscriber ID be placed on the HFL 156 until further notice. In such cases, the ASP 140 places the compromised subscriber ID on the HFL 156 and confirms that it has done so by transmitting an appropriate response to the IDP 120 at step 6c.

In the event that the subscriber's information of step 6a was in the form of a ‘report’, the IDP 120 determines the number of previous such reports and, if it exceeds a predetermined number, the IDP 120 calls the ASP 140 at step 6b requesting that the compromised subscriber ID be placed on the HFL 156 until further notice. In such cases, the ASP 140 places the compromised subscriber ID on the HFL 156 and confirms that it has done so by transmitting and appropriate response to the IDP 120 at step 6c.

The IDP 120 informs the subscriber that the compromised subscriber ID has been placed on the HFL 156 by transmitting an appropriate message to the computing device 100 at step 6d, which is displayed to the subscriber via the browser 101. The subscriber may be prompted to log into their subscriber account and change their subscriber ID.

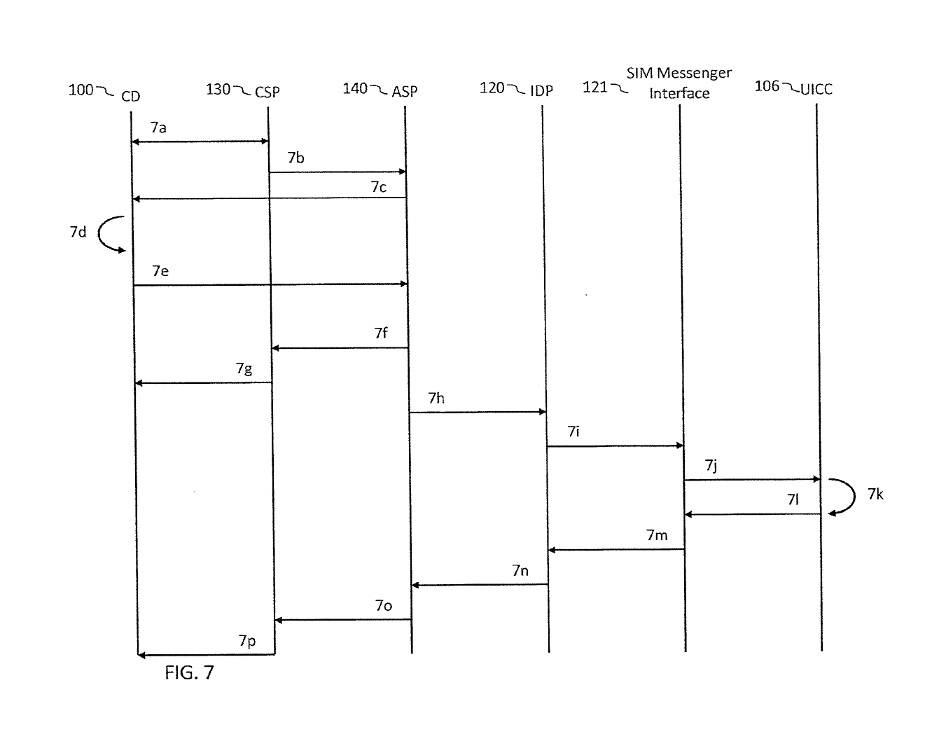

FIG. 7 shows an example of a login transaction in which the subscriber wishes to log in to an account they hold (and have already established) with a CSP 130 using their subscriber ID.

In this example, the CSP 130 is an online retailer having a website that comprises the CSP presentation layer 184 (for example an iFrame), which is a dynamic component delivered to the subscriber's browser 101, when the web server for the CSP 130 invokes the ASP 140. The ASP 140 may generate a unique transaction ID for each request and append this securely (to protect confidentiality and integrity) to the component. Based upon the identity (URL) of the requesting CSP 130 web server, the ASP 140 delivers the CSP presentation layer 184 via a Secure HTTP (HTTPS) tunnel. In such examples, the CSP 130 cannot view the subscriber ID. The component is downloaded to the subscriber browser 101, with a dynamically derived and unique session key (CSK_{C}—symmetric key used by CSP 130 to secure the response) that is encrypted using the public element of the unique asymmetric key pair (private element issued to the CSP 130 at the time of registration) of the CSP 130. For authenticity this includes use of the private element of the asymmetric key pair (public element provided to CSP 130 at time of registration) of the ASP 140.

At steps 7a and 7b, when the subscriber wishes to access the CSP's website, their computing device 100 requests and retrieves the relevant CSP web page from the CSP 130 (step 7a), in turn the CSP 130 requests a download of the ASP 140 CSP presentation layer 184 (iFrame) in step 7b. In step 7c, the ASP 140 delivers the iFrame for the subscriber to enter their subscriber ID.

The subscriber enters their subscriber ID (e.g. johndoe) into the CSP presentation layer 184 at step 7d. At step 7e, the subscriber ID is transmitted, alongwith a transaction request (via the CSP 130), using the unique session encryption key CSK_{C}, to the ASP 140.

The ASP 140 consults (not shown) the fraud and risk policy engine 155 using the subscriber ID to determine whether the subscriber ID fails any of the velocity and volume checks and to check if it is on the HFL 156.

If the subscriber ID fails any of the velocity and volume checks or is on the list of compromised IDs at the 156 HFL, then a log of the request is made in the fraud and risk policy engine 155 against the subscriber ID and the login authorization request is aborted. In such cases, the ASP 140 transmits a notification to the CSP 130 at step 7f. The CSP 130 may inform the subscriber accordingly by transmitting, at step 7g, an appropriate message for display in the browser 101. The ASP 140 also transmits a notification to the IDP 120 at step 7h. The notification may identify the type of transaction for which authorization was sought (in this case a login transaction) and the particular CSP 130. The IDP 120 logs the occurrence of the detected fraudulent activity in the CMD 123 against the consumer's record.

If the subscriber ID is not on the HFL 156, the ASP 140 need not transmit the notification of step 7f to the CSP 130. In such cases, the ASP 140 identifies the IDP 120 that is associated with the subscriber ID. The ASP 140 calls, at step 7h, a login transaction request at the correct IDP 120, which includes the subscriber ID, a CSP identifier (such as the CSP's website address) and a transaction type identifier (in this case identifying that the transaction type is a login to the CSP's website).

The IDP 120 determines that the transaction authorization request is a login transaction request based on the transaction type identifier. The IDP 120 then transmits, at steps 7i and 7j, an authentication and authorization request to the (U)SAT application 108 of the subscriber's mobile device 105, via the SIM administration and transaction messenger 121 of the IDP 120. In this example, the authentication and authorization request identifies the CSP 130 and the type of transaction for which authorization is sought (for example, specifying that CSP.com has requested authorization for login to the CSP's website).

At step 7k, the subscriber authorizes the authorization request, which may comprise accepting the transaction, declining the transaction or reporting that the transaction is fraudulent and if the subscriber accepts then they may need to authenticate themselves to the (U)SAT application 108 (for example by inputting a predetermined PIN for authorizing transactions). The (U)SAT application 108 transmits the subscriber's authorization response to the IDP 120 via the SIM administration and transaction messenger 121 at steps 7l and 7m.

In some examples, if the subscriber incorrectly enters the transaction authorization PIN a predetermined number of times at step 7k, then the (U)SAT application 108 is locked and an alert is transmitted to the IDP 120 via the SIM administration and transaction messenger 121 at steps 7l and 7m instead of the transaction authorization response. This may result in a lockout of the subscriber's service account.

If the IDP 120 received a transaction authorization response from the (U)SAT application 108 at steps 7l and 7m (instead of the lockout alert), then a log that the transaction authorization request was authenticated and authorized by the subscriber is made in the CMD 123.

If the authorization response received at steps 7l and 7m was positive, in the sense that the subscriber accepted the login request for the CSP 130, the IDP 120 selects the subscriber's pseudonym ID for the particular CSP 130 that requested authorization for the login transaction from the subscriber's record in the CMD 123. The IDP 120 transmits, at step 7n, the subscriber's pseudonym ID to the ASP 140, along with the authorization response.

If the authorization response received at step 7l and 7m was negative, in the sense that the subscriber declined the login request for the CSP 130, the IDP 120 transmits, at step 7n, the (negative) authorization response to the ASP 140, along with the subscriber ID.

If the subscriber indicated in the authorization response of steps 7l and 7m that the transaction for which authorization was sought is fraudulent, then the IDP 120 makes a log of such fraudulent activity in the CMD 123. In such cases, the IDP 120 transmits the authorization response (in this case indicating that the transaction is fraudulent) to the ASP 140, at step 7n. If the IDP 120 determines that a predetermined number of fraudulent activities have previously been recorded in the CMD 123 against the subscriber ID, the authorization response may include a request to place the subscriber ID on the HFL 156.

After receiving the authorization response of step 7n, the ASP 140 determines the appropriate action to be taken based on the authorization response.

If the subscriber correctly authenticated the transaction authorization request and indicated that they accepted the transaction, then the ASP 140 logs the transaction in the audit, account and report engine 148, the transaction archive 149 and the billing engine 154. The log may include the unique transaction ID, the subscriber's pseudonym ID for CSP 130, the time (for example, of authorization by the subscriber), the type of transaction for which authorization was sought (in this example, login) and a CSP identifier,

At step 7o, the ASP 140 transmits a positive (authenticated and accepted) authorization response message, along with the transaction ID and the subscriber's pseudonym ID for the CSP 130 to the CSP 130. The CSP 130 informs the subscriber accordingly at step 7p. The subscriber is then allowed access to their account with the CSP 130.

If the subscriber declined the transaction or indicated that the transaction was fraudulent, then the ASP 140 makes a corresponding log in the audit, account and report engine 148, the transaction archive 149 and the billing engine 154. At step 7o, the ASP 140 transmits a negative (declined or reported as being fraudulent) authorization message to the CSP 130 along with an appropriate failure code (for example for enabling the CSP 130 to determine whether the transaction was declined or fraudulent). If an error occurred (for example, if the subscriber ID was not found, if there was an authentication timeout or the like), the subscriber is returned to the login page and a suitable error message is shown to the subscriber. JavaScript in the CSP presentation layer 131 may handle interpretation of the error code for the unsuccessful login. The CSP 130 informs the subscriber accordingly at step 7p.

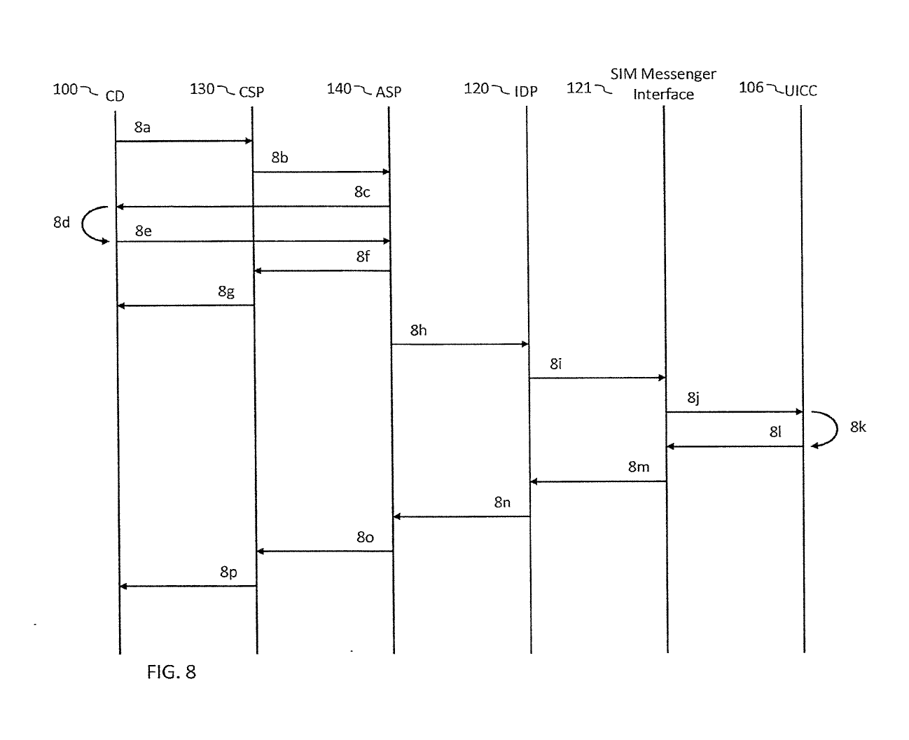

FIG. 8 shows an example of a payment transaction in which the subscriber wishes to make a payment via a CSP 130. In this example, the CSP 130 may be an online banking portal in which the subscriber is provided with an opportunity to make a bank payment (for example to set up a new beneficiary or to pay an existing beneficiary) via their online bank account.

Similarly to steps 7a to 7c, at steps 8a to 8c, the subscriber accesses the CSP's website and selects an option to make a payment using their subscriber ID on the CSP's webpage.

If the subscriber is not already logged into their account with the CSP 130 (in a manner described above in relation to FIG. 7 or otherwise), then, the subscriber enters their subscriber ID (e.g. johndoe) into the CSP presentation layer 184 at step 8d. At step 8e the unique session encryption key CSK_{C}, is used to transmit to the ASP 140, the subscriber ID, along with transaction request (via the CSP 130) details such as the transaction ID, an identifier for the CSP 130 (for example the CSP's URL and/or trading name), the beneficiary name, the beneficiary account number and amount of payment for which authorization is sought (if applicable).

If the subscriber is already logged in to their account with the CSP 130, then at subscriber does not have to provide their subscriber ID in step 8d and in step 8e the CSP 130 calls the ASP 140 and provides the subscriber's pseudonym ID (instead of the subscriber ID), along with all other details previously identified.

The ASP 140 then performs real-time background checks (not shown in FIG. 8) and queries the fraud and risk policy engine 155 and uses the subscriber ID (if the user is already logged in then via a cached mapping between subscriber IDs and pseudonym IDs) to determine whether or not the subscriber ID passes the fraud and risk policy engine 155 rules (for example volume and velocity) and is on the HFL 156.

If the subscriber ID fails the fraud and risk policy engine 155 rules or is on the HFL, then the ASP 140 makes a corresponding log in the relevant systems (the fraud and risk policy engine 155, the transaction archive 149 and the audit, account and report engine 148) and the transaction authentication request is aborted. The ASP 140 transmits a notification accordingly to both the CSP 130 at step 8f (who may notify the subscriber at step 8g) and the IDP 120 at step 8h. The notification of step 8h to the IDP 120 includes an identification of the type of transaction for which authorization was sought and an identification of the CSP 130. The IDP 120 makes a corresponding log in the CMD 123 record for the subscriber.

If the subscriber ID passes the fraud and risk poly engine 155 rules and is not on the HFL 156, then the ASP 140 identifies the issuing IDP 120 and calls, at step 8h, the IDP 120 with a transaction authorization request identifying the subscriber ID, transaction ID, a CSP identifier (for example the CSP's URL) and an identification of the type of transaction for which authorization is sought (in this example, a bank payment).

If the subscriber was logged in via their subscriber ID, then the ASP 140 identifies the issuing IDP 120, using the pseudonym ID, and calls the issuing IDP 120 with a transaction authorization request identifying the subscriber ID, transaction ID, a CSP identifier (for example the CSP's URL) and an identification of the type of transaction for which authorization is sought (in this example, a bank payment).

The IDP 120 determines that the transaction authorization request is a payment transaction request based on the transaction type identifier. Processing proceeds in steps 8i to 8p similarly to corresponding steps 7i to ‘7p described above in relation to FIG. 7.

In some examples, the subscriber may wish to make a Cardholder Not Present (CNP) payment to the CSP 130 in respect of the purchase of goods and/or services from the CSP 130.

In such examples, processing is similar to that described above in relation to FIG. 7. However, prior to step 8h, the ASP 140 accesses the merchant record for the CSP 130 in the CSP configuration store 182 and extracts the merchants CNP payment (for example which instruments are accepted, such as Visa, MasterCard and JCB) and delivery preferences (for example which countries are deliveries made to).

Similarly, prior to step 8i, the IDP 120 accesses the consumer record for the subscriber in the CMD 123 and extracts the subscriber's CNP options and, if required, the delivery options; the payments instruments and delivery addresses that the subscriber has registered against their account for CNP payments. The IDP 120 transmits, at steps 8i and 8j, an authentication and authorization message to the (U)SAT application 108 of the subscriber's mobile device 105 which includes the CNP and shipping options available for the subscriber. The (U)SAT application 108 prompts the subscriber to select one of the payment options and delivery options, for example by displaying a drop-down list of the different options. The subscriber selects one payment option and one delivery option at step 8k. The IDP 120 receives an authorization response from the (U)SAT application 108, at steps 8l and 8m, which also includes an indication of which of the payment instrument and delivery options the subscriber has selected for the CNP payment transaction. The IDP 120 transmits an appropriate transaction authorization response to the ASP 140, at step 8n, which includes the selected payment instrument details (for example the PAN, expiry date, CCV, issue number and billing address) and delivery details.

The ASP 140 may pass all of the details back to the requesting merchant (CSP 130) as part of step 80. Alternatively, if the merchant has set a preference in the CSP configuration store 182 to pass all card details to a third party payment processor (for example MA 160), then the ASP 140 may pass on delivery details and any other requested non-payment instrument related information back to the CSP 130 in step 8o and wait for a call from MA 160, specifically ASP security and configuration 166 on the MA interface 143, with a matching transaction ID. All payment instrument details required to authorize the transaction with the payment instrument issuing institution are then passed from the ASP 140 to the MA 160 for processing. This enables the CSP 130 to continue to benefit from its existing MA 160 relationships to process payments.

The ASP 140 makes a corresponding log in the billing engine 154, transaction archive 149 and the audit, account and report engine 148. The log may include the transaction ID, subscriber ID, the time (of the subscriber authorizing the CNP payment or of some other predetermined event), the type of transaction for which authorization was sought (in this case, the CNP payment transaction) and the identity of the CSP 130. In such cases, the ASP 140 transmits an acceptance message to the CSP 130 including the subscriber's pseudonym ID and indicating the result of the CNP payment. The subscriber is informed accordingly.

In some examples, the CSP 130 provides the subscriber with an option to undergo a credit score check in order to register for a new store credit card or other credit-related goods or services from the CSP.

Again, in such examples, processing is similar to that described above inrelation to FIG. 7 and in relation to the CNP payment transaction.

However, the ASP 140 is configured to perform a credit reference check for the subscriber with the CRA 170, instead of a real-time fund authorization request with the MA 160. In particular, the ASP 140 transmits a real-time credit reference check request to the CRA 170 via the CRA interface 144. The request includes the subscriber's name and address details (current and for the last five years). The CRA 170 responds with a real-time credit reference check response (for example indicating a credit score between 0 and 100). The ASP 140 logs the response in the audit, account and report engine 148, transaction archive 149 and the billing engine 154 logs. This includes the transaction ID and pseudonym ID for the subscriber in respect of the CSP 130 that requested the credit check, the time (for example, of receipt of the response from the CRA 170), an identification of the type of transaction (in this example, a credit check transaction) and an identification of the CSP 130. The ASP 140 transmits the credit score and pseudonym ID to the CSP 130. The CSP 130 assesses the credit score and provides the subscriber with a success or failure message.

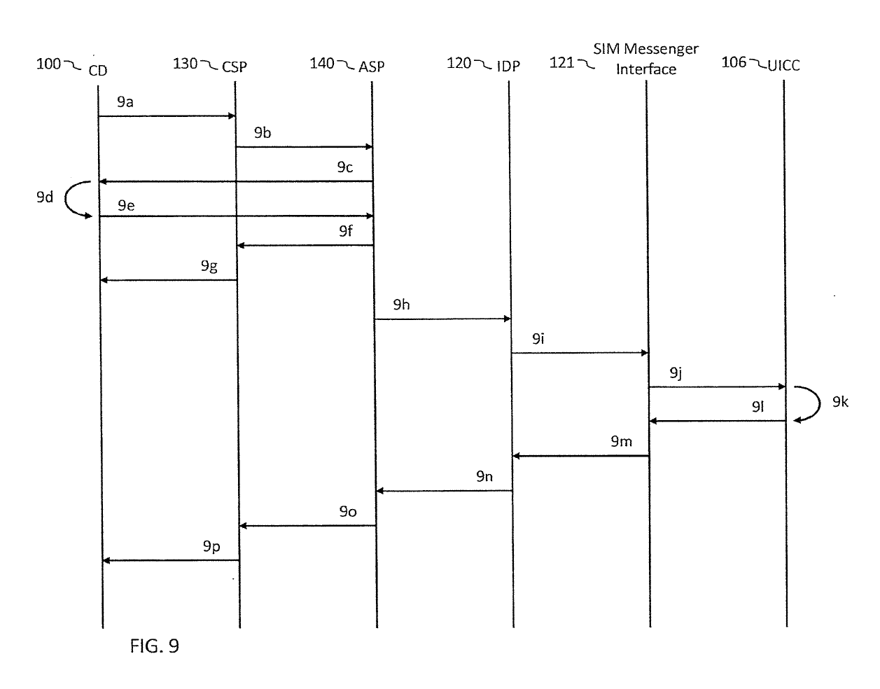

FIG. 9 shows an example of a new profile registration transaction in which the subscriber wishes to register for an account with a CSP 130. In this example, the subscriber is provided with an opportunity to register for an account with the CSP 130 using their subscriber ID. By using the subscriber ID, the ASP 140 can provide the CSP 130 with the required (set by the CSP 130 in its CSP configuration store 182) registration information for the subscriber from the CMD 123 of the IDP 120 without the subscriber having to provide the registration information directly to the CSP 130.

Processing in steps 9a to 9p is similar to steps 7a to ‘7p and 8a to 8p discussed above.

In relation to FIG. 9, if the authorization response received by the IDP 120 at step 9l was positive, in the sense that the subscriber authorized the new profile request for the CSP 130, the IDP 120 selects the subscriber's pseudonym ID for the particular CSP 130 that requested authorization for the new profile transaction from the subscriber's record 300 in the CMD 123. The IDP 120 also accesses profile information for the subscriber from the subscriber's record in the CMD 123, which profile information is provided to the CSP 130 for the purposes of creating the new profile for the subscriber with the CSP 130. The IDP 120 transmits, at step 9n, the subscriber's pseudonym ID to the ASP 140, along with the authorization response and the profile information for the subscriber.

After receiving the authorization response of step 9n, the ASP 140 determines the appropriate action to be taken based on the authorization response.

If the subscriber correctly authenticated the transaction authorization request and indicated that they accepted the transaction, then the ASP 140 logs the transaction in the transaction archive 149, audit, account and report engine 148 and the billing engine 154. The log includes the transaction ID, subscriber's pseudonym ID for the transaction, the time (for example, of authorization by the subscriber), the type of transaction for which authorization was sought (in this example, new profile request) and a CSP identifier. At step 9o, the ASP 140 transmits a positive (authenticated and accepted) authorization response message, along with the subscriber's pseudonym ID for transactions with the CSP 130 and the subscriber's profile information for the new account with the CSP 130 to the CSP 130. The subscriber is informed accordingly at step 9p.

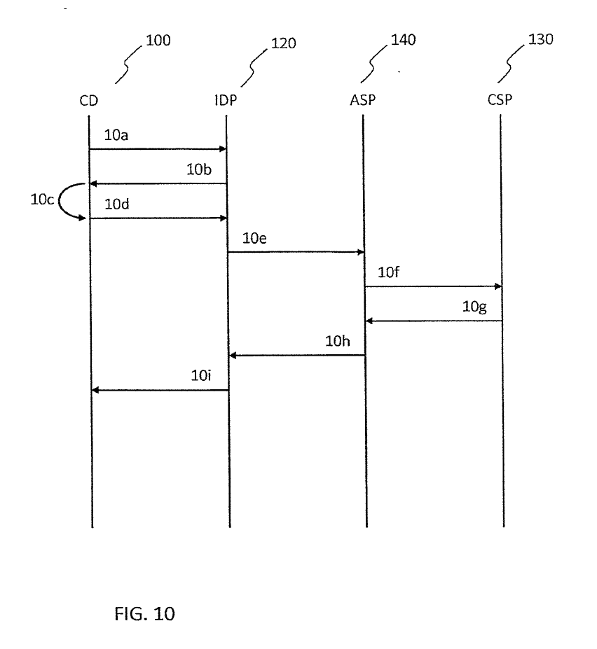

FIG. 10 shows an example of a subscriber profile update transaction in which the subscriber wishes to update profile information contained in their consumer record in the CMD 123 at the IDP 120. In this example, the subscriber can update corresponding profile data at one or more CSPs 130 with which they have previously transacted by updating their consumer profile, for example via the CMP 122 at the IDP 120.

At steps 10a and 10b, the subscriber requests access to the CMP 122 for updating their subscriber profile via the browser 101 of their computing device 100 and receives a profile update webpage from the IDP 120. At step 10c, the subscriber updates some of their personal information, for example reflecting a change in their e-mail address, via the CMP 122. The computing device 100 transmits the updated profile information to the IDP 120 at step 10d. The IDP 120 identifies all of the CSPs 130 to whom the subscriber has previously provided their e-mail address, for example by querying the subscriber's record in the CMD 123.

At step 10e, the IDP 120 makes an appropriate call via the ASP interface 124 to the ASP 140. The call identifies the type of transaction (in this example, a profile maintenance transaction), the updated field(s) (in this example, e-mail address) and the updated value of the field(s) (in this example, the subscriber's new e-mail address), the CSP or CSPs 130 to whom the profile update should be transmitted, and the subscriber's pseudonym ID for each of the CSPs 130. The CSP or CSPs 130 to whom the profile update should be transmitted may be the full set of CSPs 130 with whom the subscriber has previously transacted or a subset of such CSPs 130. For example, the subscriber may be provided with a list of the full set of CSPs 130 with whom the subscriber has previously transacted and the subscriber can select a subset of CSPs 130 to whom the profile update should be transmitted.

At step 10f, the ASP 140 calls each CSP 130 (indicated by a single arrow to CSP 130 in FIG. 10) to whom the profile update should be transmitted with the subscriber's pseudonym ID for that CSP 130 and the updated field information (field type and updated value).

Then each CSP 130 performs any updates to their local record for the subscriber. Subsequently, each CSP 130 transmits (indicated by a single arrow from CSP 130 in FIG. 10), via the ASP interface 132, an acknowledgement message at step 10g. The acknowledgement message may indicate successful receipt and update of the local records for the CSP 130. The acknowledgement message may also indicate whether any of the updates were unsuccessful, for example if the subscriber's account was not recognized by the CSP 130. In such cases, the acknowledgement message may include an appropriate failure code so that the ASP 140 can determine why the update request was unsuccessful.

The ASP 140 logs details of the profile update transaction, including the subscriber's pseudonym ID (against each CSP 130), the transaction type (in this example, a profile update transaction), the identity of the CSP 130 and the identity of the relevant IDP 120 in the billing engine 154, transaction archive 149 and audit, account and report engine 148.

At step 10h, the ASP transmits to the IDP 120 a profile update response message which may identify whether the profile update was successfully implemented by each of the CSPs 130 to which it was sent in step 10f.

The IDP 120 then updates the record for the subscriber in the CMD 123 and provides the subscriber with the result of the profile update request at step 10i.

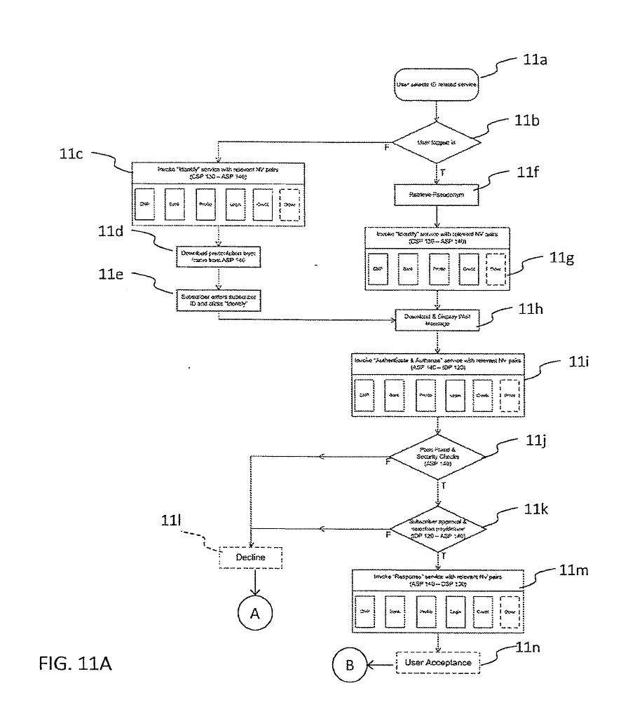

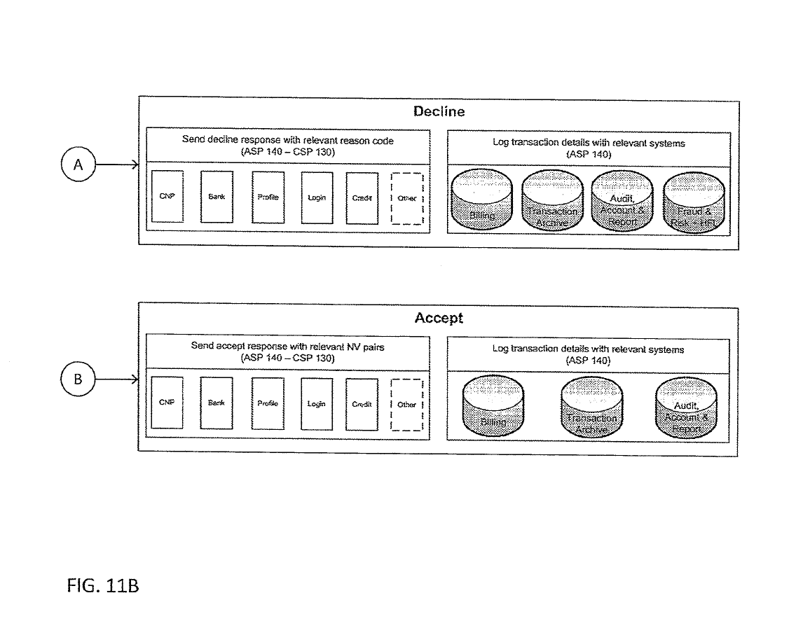

FIGS. 11A and 11B show a general overview of an exemplary transaction authorization request and response procedure according to some embodiments.

At step 11a, the subscriber selects a service provided by a CSP 130 (in this case a merchant).

At step 11b, the CSP 130 determines whether the subscriber is logged into the CSP's service.

If the determination at step 11b is ‘false’, in other words if the subscriber was not logged in, at step 11b, the CSP 130 makes a call to an identity function via the subscriber's browser 101 and the CSP presentation layer 184 to the ASP 140 with the relevant name-value pairs for the service that the subscriber wishes to use. For example, the call may include a name-value pair identifying that the subscriber wishes to make a CNP payment and identifying the amount of the payment.

At step 11d, the CSP 130 downloads the presentation later (for example an iFrame) from the ASP 140 via the CSP presentation layer 184 and the subscriber's browser 101 into which the subscriber may enter their subscriber ID.

At step 11e, the subscriber ID is transmitted to the ASP 140.

If the determination at step 11b is ‘true’, in other words if the subscriber was logged in, at step 11f, the CSP 130 retrieves the subscriber's pseudonym ID; the ID for the subscriber in respect of the particular CSP 130.

At step 11g, the CSP 130 makes a call to an identity function via the subscriber's browser 101 and the CSP presentation layer 184 to the ASP 140 with the subscriber ID and relevant name-value pairs for the service that the subscriber wishes to use. For example, the call may include a name-value pair identifying that the subscriber wishes to make a CNP payment and identifying the amount of the payment itself.

At step 11h, following either step 11e or 11g (as appropriate), the presentation layer 131 displays a wait message to the subscriber.

At steps 11i and 11j, the ASP 140 checks to ensure the transaction passes all relevant fraud and risk policy engine 155 rules and that the subscriber ID is not on the HFL 156.

If the result of the determination at step 11j is ‘false’, in other words if the transaction fails either test due to fraud and security suspicion, then the transaction is declined at step 11l. With reference to FIG. 11B, the declined transaction is logged in the transaction archive 149, billing engine 154, audit, account and report engine 148, as well as the fraud and risk policy engine 155 and the HFL 156. The CSP 130 is informed via the CSP presentation layer 184 that the transaction was declined.

If the result of the determination at step 11j is ‘true’, in other words if the if the transaction passes both tests due to fraud and security suspicion, then the ASP 140 makes a call at step Ilk to the IDP 120 which transmits an authentication and authorization request message to the (U)SAT application 108 via the SIM administration and transaction messenger 121. The (U)SAT application 108 identifies the transaction to the subscriber and requests authentication by the subscriber. If the subscriber correctly authenticates, and authorizes the transaction (and, optionally, selects a payment instrument and delivery address from potentially multiple options), the (U)SAT application 108 transmits a response message to the IDP 120 via the SIM administration and transaction messenger 121.

If the result of the determination at step Ilk is ‘false’, in other words if the subscriber did not approve the transaction, then the transaction is declined at step 11l. With reference to FIG. 11B, the declined transaction is logged in the transaction archive 149, billing engine 154, audit, account and report engine 148, as well as the fraud and risk policy engine 155 and the HFL 156. The CSP 130 is informed via the CSP presentation layer 184 and the subscriber's browser (relays the data to the CSP security and configuration 133 at the CSP 130) that the transaction was declined.

If the result of the determination at step Ilk is ‘true’, in other words if the subscriber approved the transaction, then the IDP 120 makes a call to a response function of the ASP 140 via the ASP interface 124 and the IDP interface 141, where any additional processing by third parties such as MA 160 is managed by the ASP 140.

At step 11m and 11n the ASP 140 determines that the subscriber has approved the transaction authorization request. With reference to FIG. 11B, the ASP 140 informs the CSP 130 that the transaction was authorized and returns the relevant name-value pairs and pseudonym ID to the CSP 130 via the CSP presentation layer 184 and the subscriber's browser, which relays the data to the CSP security and configuration 133 at the CSP 130. The accepted transaction is logged in the transaction archive 149, billing engine 154, audit, account and report engine 148, as well as the fraud and risk policy engine 155 and the HFL 156.

In certain examples described above, the ASP 140 may be seen to be a trusted mediator, enabling a single point of integration, for ID-related credential exchange, between all parties (RP, IdP and Third Party Validator). The CMD 123 may be seen to be a credential vault having an electronic locker capability which enables subscribers to have complete ownership of their subscriber ID. Access to the CMD 123 is controlled via the subscriber's mobile device 105. The subscriber may be able to port their subscriber profile from the CMD 123 to that of another IDP 120 (for example another IDP). The CMP 122 may be seen to be a web portal, which allows a subscriber to view and maintain all of their credentials via a single portal, rather than having to maintain all of their specific credentials with the individual RPs or CSPs 130.

Certain of the examples described above may be seen to provide an ‘eco-system’ which may deliver improvements in both security and convenience in managing online identities. A subscriber's credentials (for example, the subscriber's name, address, and credit card details) may be stored in a secure electronic credentials vault. The subscriber is requested to authenticate themselves and authorize any attempt to exchange and assert the credentials, in real-time, for example via their mobile device.

The above examples are to be understood as illustrative examples of the disclosure. Further examples and embodiments of the disclosure are envisaged. For example:

In some of the examples described above, the (U)SAT application 108 authenticates the subscriber locally in the sense that it has prior knowledge of the secret PIN that the subscriber must enter into the (U)SAT application 108 in order to complete authentication. In other embodiments, the (U)SAT application 108 may not have prior knowledge of the subscriber's secret PIN. For example, the secure PIN may be generated by the IDP 120 and stored securely in the CMD 123 for the consumer. In such examples, the (U)SAT application 108 may prompt the consumer for their secret PIN and transmit the PIN input by the consumer to the IDP 120 via the SIM messenger 111. Such transmission may be encrypted, for example using the transaction encryption key MTK_{c}. In response to receiving the encrypted PIN input by the consumer, the SIM administration and transaction messenger 121 may decrypt the encrypted PIN and compare the decrypted PIN with the secret PIN stored in the CMD 123 for the consumer. In some examples, for example if the authentication was not successful, the SIM administration and transaction messenger 121 may then transmit an authentication response to the (U)SAT application 108.

In certain examples described above, the CSP 130 has been described as being an online merchant. Other types of CSP 130 are envisaged. For example, the CSP 130 might be a television shopping channel. In such examples, the subscriber may see a product that they wish to purchase on the television and telephone the telephone shopping channel to order the product. The CSP 130 may request authorization of the transaction via the ASP 140 in the manner described in detail above. In particular, the subscriber may be request to authorize the transaction with the television shopping channel via their mobile device 105.

In certain of the examples described above, the transaction for which authorization is sought has been described as being an Internet-based transaction. However, other types of transaction such as telephone and mail order transactions are envisaged.

In certain of the examples described above, the SIM messenger 111 is described as being under the control of the MNO 110 (or being at the MNO's premises). In other examples of the disclosure, the SIM messenger may be hosted at the ASP 140, with the approval of the MNO 110.

In certain of the examples described above, the SIM messenger 111 establishes a secure session with the (U)SAT application 108, by means of which the subscriber can authorize transactions. In other examples of the disclosure, the telecommunications device may be capable of Near Field Communications (NFC); a short-range wireless communication technology. In such examples, the NFC-enabled telecommunications device comprises a Secure Element (SE) which may be a UICC, a secure element embedded in the telecommunications device, a secure memory card (such as a (micro) Secure Digital (SD) card) or the like. The SE is issued by an SE issuer, which may be a dedicated SE-issuing entity, an IDP 120, MNO 110 or another entity. The SE comprises a tag that an NFC reader can power and read by magnetic induction. The SE and hosts (secure) applications issued by application issuers. Such applications may be used to authorize an authorization request (for example for a transaction) involving the subscriber and a relying party in a similar manner to that described above in relation to the (U)SAT application 108.

In certain of the examples described above (for example with reference to FIG. 4), a master key MK_{C} and session key SK_{C} are used to establish secure communications between the U(SAT) application 108 and the SIM messenger server 111. In other examples of the disclosure, asymmetric cryptographic techniques, for example using digital certificates, could be used to provide the secure communications.

In certain of the examples described above, the MNO 110 and IDP 120 are shown to be separate entities. However, the functionality of the MNO 110 may be combined with that of the IDP 120 to provide a single entity (for example at the MNO's premises) which is responsible for handling communications to and from the telecommunications device and for handling ID-related services.

In certain of the examples described above, the computing device 100, which includes the browser 101, and the mobile device 105 are shown to be separate entities. However, a single device may provide both functionalities. For example, the subscriber may have a mobile device 105 which has a browser that that can be used to access the CSP's presentation 131 to interact with the CDP 130. The subscriber may, in such cases, receive a transaction authorization request via the (U)SAT application 108 on the same mobile device 105 as that which they use to access the CSP 130.

In some examples, the UICC 106 is described as being removable from the communications device 105. In other examples, the UICC 106 may not be removable from the communications device 105 and may be built into it, for example in a microprocessor that has a trusted element such as the Intel Trusted Platform module or the ARM TrustZone.

In some examples, the (U)SAT application 108 is used as a trusted application. However, other types of current and future trusted applications are envisaged.

It is to be understood that any feature described in relation to any one example or embodiment may be used alone, or in combination with other features described, and may also be used in combination with one or more features of any other of the examples or embodiments, or any combination of any other examples or embodiments. Furthermore, equivalents and modifications not described above may also be employed without departing from the scope of the disclosure, which is defined in the accompanying claims.

1. A method of obtaining authorization from a subscriber to an authorization service provided by an authorization provider in a data communications system, the data communications system comprising:
a plurality of authorization providers configured to receive authorization requests sent on behalf of a plurality of relying parties; and
a plurality of telecommunications devices, the method comprising:
receiving at a telecommunications device an authorization request, the request including data identifying one or more details of a transaction to be authorized;
displaying on the telecommunications device said data identifying one or more details of the transaction to be authorized;
receiving user input authorizing the transaction; and
transmitting an authorization response from the telecommunications device, the authorization response indicating that the user has authorized the transaction.

2. A computer program product comprising a non-transitory computer-readable storage medium having computer readable instructions stored thereon, the computer readable instructions being executable by a computerized device to cause the computerized device to perform a method for obtaining authorization from a subscriber to an authorization service provided by an authorization provider in a data communications system, the data communications system comprising:
a plurality of authorization providers configured to receive authorization requests sent on behalf of a plurality of relying parties; and
a plurality of telecommunications devices, the method comprising:
receiving at a telecommunications device an authorization request, the request including data identifying one or more details of a transaction to be authorized;
displaying on the telecommunications device said data identifying one or more details of the transaction to be authorized;
receiving user input authorizing the transaction; and
transmitting an authorization response from the telecommunications device, the authorization response indicating that the user has authorized the transaction.
